(19) United States
(12) Patent Application Publication
(10) Pub. No.: US 2026/0064096 A1
(43) Pub. Date: Mar. 5, 2026

(54) BUILDING MANAGEMENT SYSTEM WITH SENSOR HEALTH MODEL

(71) Applicant: Tyco Fire & Security GmbH, Neuhausen am Rheinfall (CH)

(72) Inventors: Louis Nunzio Loizides, Safety Harbor, FL (US); Abhishek Uday Khardenavis, Pune (IN)

(21) Appl. No.: 18/817,631

(22) Filed: Aug. 28, 2024

(51) Int. Cl. G05B 19/042

(52) U.S. Cl. CPC G05B 19/042; G05B 2219/25011

(57) ABSTRACT

A sensor health system for building equipment obtains sensor data measuring a variable state or condition affected by operating the building equipment, classifies the sensor data into a particular mode of a plurality of modes corresponding to a plurality of operating states of the building equipment, generates a mode-specific distribution of the sensor data corresponding to the particular mode of the plurality of modes, identifies the sensor data as abnormal by comparing the mode-specific distribution of the sensor data to an expected mode-specific distribution selected from a plurality of expected mode-specific distributions corresponding to the plurality of modes, and initiates a corrective action in response to identifying the sensor data as abnormal.

### BACKGROUND

The present disclosure relates generally to building management systems (BMSs) for monitoring and/or controlling a building or campus. The present disclosure relates more particularly to a BMS with fault detection and diagnostics (FDD) using machine learning to assess building equipment health.

A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof. To ensure building equipment in a BMS is operating correctly, data sets related to operation of the building equipment are typically analyzed to detect and diagnose faults or other issues that could lead to degraded equipment performance if left unresolved. Analytics typically require reliable data for operation or will return erroneous results. Accordingly, it can be important in a BMS to ensure the reliability and accuracy of the sensor data used to perform analytics.

Conventional FDD systems used to assess sensor health typically rely on hard coded rules (e.g., threshold comparisons to minimum or maximum values) to determine whether the data from the sensor is reasonable or accurate. However, hard coded rules have several drawbacks including lack of scalability (i.e., rules can be difficult to manage or generate for new sensors and ranges) and inability to detect subtle changes in operation such as bias or oscillation. In many cases, hard coded rules will represent a larger range of values than is useful to determine erroneous states. For example, a hard coded rule with a minimum and maximum threshold might be used to evaluate performance of the building equipment in multiple different operating states that have different normal characteristics. Such a rule might fail to detect abnormal equipment operation in one state if the detected operation is normal for another state encompassed by the rule. Additionally, conventional FDD systems often are not able to reliable detect bad sensors or distinguish between bad sensors and abnormal equipment operation.

### SUMMARY

One implementation of the present disclosure is a sensor health system for building equipment. The sensor health system includes one or more processors and one or more non-transitory computer-readable media storing instructions that, when executed by the one or more processors, cause the one or more processors to perform operations. The operations include obtaining sensor data measuring a variable state or condition affected by operating the building equipment, classifying the sensor data into a particular mode of a plurality of modes corresponding to a plurality of operating states of the building equipment, generating a mode-specific distribution of the sensor data corresponding to the particular mode of the plurality of modes, identifying the sensor data as abnormal by comparing the mode-specific distribution of the sensor data to an expected mode-specific distribution selected from a plurality of expected mode-specific distributions corresponding to the plurality of modes, and initiating a corrective action in response to identifying the sensor data as abnormal.

In some embodiments, the operations include obtaining an expected multi-modal distribution including the plurality of expected mode-specific distributions, identifying a corresponding mode for each of the plurality of expected mode-specific distributions in the expected multi-modal distribution, and selecting the expected mode-specific distribution in response to determining that the expected mode-specific distribution corresponds to the particular mode into which the sensor data are classified.

In some embodiments, the operations include generating an expected multi-modal distribution including the plurality of expected mode-specific distributions by classifying a set of training data into each of the plurality of modes, generating, for each mode of the plurality of modes, an expected mode-specific distribution for the mode using a portion of the set of training data classified into the mode, and generating the expected multi-modal distribution by incorporating each expected mode-specific distribution into the expected multi-modal distribution.

In some embodiments, identifying the sensor data as abnormal includes using a machine learning model to determine an abnormality of the mode-specific distribution of the sensor data relative to the expected mode-specific distribution and identifying the sensor data as abnormal in response to the abnormality exceeding a threshold.

In some embodiments, classifying the sensor data includes classifying a first portion of the sensor data into a first mode of the plurality of modes and classifying a second portion of the sensor data into a second mode of the plurality of modes, generating the mode-specific distribution includes generating a first mode-specific distribution of the sensor data using the first portion of the sensor data classified into the first mode and generating a second mode-specific distribution of the sensor data using the second portion of the sensor data classified into the second mode, and identifying the sensor data as abnormal includes comparing the first mode-specific distribution of the sensor data to a first expected mode-specific distribution corresponding to the first mode and comparing the second mode-specific distribution of the sensor data to a second expected mode-specific distribution corresponding to the second mode.

In some embodiments, identifying the sensor data as abnormal includes using a first machine learning model to determine a first abnormality of the first mode-specific distribution of the sensor data relative to the first expected mode-specific distribution, using a second machine learning model to determine a second abnormality of the second mode-specific distribution of the sensor data relative to the second expected mode-specific distribution, and identifying the sensor data as abnormal in response to at least one of the first abnormality or the second abnormality exceeding a threshold.

In some embodiments, identifying the sensor data as abnormal includes using a single machine learning model to determine both a first abnormality of the first mode-specific distribution of the sensor data relative to the first expected mode-specific distribution and a second abnormality of the second mode-specific distribution of the sensor data relative to the second expected mode-specific distribution and identifying the sensor data as abnormal in response to at least one of the first abnormality or the second abnormality exceeding a threshold.

In some embodiments, initiating the corrective action includes at least one of transmitting the sensor data to an analyst and obtaining feedback from the analyst; initiating maintenance, repair, or replacement of the building equipment or a sensor from which the sensor data are obtained; stopping one or more artificial intelligence models or machine learning models that consume the sensor data; or disabling the building equipment or operating other building equipment to work around a fault in the building equipment.

In some embodiments, initiating the corrective action includes at least one of causing the sensor data to be discarded or withheld from one or more systems or processes that consume the sensor data, preventing the sensor data from being used to operate the building equipment or train a model used to operate the building equipment, or withholding the sensor data from one or more user interfaces used to monitor operation of the building equipment.

In some embodiments, the operations include labeling the sensor data as abnormal in response to identifying the sensor data as abnormal and labeling the sensor data as normal in response to identifying the sensor data as normal.

Another implementation of the present disclosure is building management system including one or more processors and one or more non-transitory computer-readable media storing instructions that, when executed by the one or more processors, cause the one or more processors to perform operations. The operations include obtaining timeseries data relating to operation of building equipment, classifying the timeseries data into a particular mode of a plurality of modes corresponding to a plurality of operating states of the building equipment, generating a mode-specific distribution of the timeseries data corresponding to the particular mode of the plurality of modes, identifying the timeseries data as abnormal by comparing the mode-specific distribution of the timeseries data to an expected mode-specific distribution selected from a plurality of expected mode-specific distributions corresponding to the plurality of modes, and initiating a corrective action in response to identifying the timeseries data as abnormal.

In some embodiments, the operations include generating an expected multi-modal distribution including the plurality of expected mode-specific distributions by classifying a set of training data into each of the plurality of modes, generating, for each mode of the plurality of modes, an expected mode-specific distribution for the mode using a portion of the set of training data classified into the mode, and generating the expected multi-modal distribution by incorporating each expected mode-specific distribution into the expected multi-modal distribution.

In some embodiments, classifying the timeseries data includes a first portion of the timeseries data into a first mode of the plurality of modes and classifying a second portion of the timeseries data into a second mode of the plurality of modes, generating the mode-specific distribution includes generating a first mode-specific distribution of the timeseries data using the first portion of the timeseries data classified into the first mode and generating a second mode-specific distribution of the timeseries data using the second portion of the timeseries data classified into the second mode, and identifying the timeseries data as abnormal includes comparing the first mode-specific distribution of the timeseries data to a first expected mode-specific distribution corresponding to the first mode and comparing the second mode-specific distribution of the timeseries data to a second expected mode-specific distribution corresponding to the second mode.

In some embodiments, identifying the timeseries data as abnormal includes using a first machine learning model to determine a first abnormality of the first mode-specific distribution of the timeseries data relative to the first expected mode-specific distribution, using a second machine learning model to determine a second abnormality of the second mode-specific distribution of the timeseries data relative to the second expected mode-specific distribution, and identifying the sensor data as abnormal in response to at least one of the first abnormality or the second abnormality exceeding a threshold.

In some embodiments, identifying the timeseries data as abnormal includes using a single machine learning model to determine both a first abnormality of the first mode-specific distribution of the timeseries data relative to the first expected mode-specific distribution and a second abnormality of the second mode-specific distribution of the timeseries data relative to the second expected mode-specific distribution and identifying the timeseries data as abnormal in response to at least one of the first abnormality or the second abnormality exceeding a threshold.

Another implementation of the present disclosure is a method for initiating corrective actions for building equipment. The method includes obtaining timeseries data relating to operation of the building equipment, classifying the timeseries data into a particular mode of a plurality of modes corresponding to a plurality of operating states of the building equipment, generating a mode-specific distribution of the timeseries data corresponding to the particular mode of the plurality of modes, identifying the timeseries data as abnormal by comparing the mode-specific distribution of the timeseries data to an expected mode-specific distribution selected from a plurality of expected mode-specific distributions corresponding to the plurality of modes, and initiating a corrective action in response to identifying the timeseries data as abnormal.

In some embodiments, the method includes generating an expected multi-modal distribution including the plurality of expected mode-specific distributions by classifying a set of training data into each of the plurality of modes, generating, for each mode of the plurality of modes, an expected mode-specific distribution for the mode using a portion of the set of training data classified into the mode, and generating the expected multi-modal distribution by incorporating each expected mode-specific distribution into the expected multi-modal distribution.

In some embodiments, classifying the timeseries data includes classifying a first portion of the timeseries data into a first mode of the plurality of modes and classifying a second portion of the timeseries data into a second mode of the plurality of modes, generating the mode-specific distribution includes generating a first mode-specific distribution of the timeseries data using the first portion of the timeseries data classified into the first mode and generating a second mode-specific distribution of the timeseries data using the second portion of the timeseries data classified into the second mode, and identifying the timeseries data as abnormal includes comparing the first mode-specific distribution of the timeseries data to a first expected mode-specific distribution corresponding to the first mode and comparing the second mode-specific distribution of the timeseries data to a second expected mode-specific distribution corresponding to the second mode.

In some embodiments, identifying the timeseries data as abnormal includes using one or more machine learning models to determine a first abnormality of the first mode-specific distribution of the timeseries data relative to the first expected mode-specific distribution, using the one or more machine learning models to determine a second abnormality of the second mode-specific distribution of the timeseries data relative to the second expected mode-specific distribution, and identifying the sensor data as abnormal in response to at least one of the first abnormality or the second abnormality exceeding a threshold.

In some embodiments, classifying the timeseries data into the particular mode includes using at least one of a machine learning model or operating states of the building equipment to determine the particular mode based on data characterizing operation of the building equipment at a time when the timeseries data are generated or collected.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drawing of a building equipped with a HVAC system, according to some embodiments.

FIG. 2 is a block diagram of a waterside system which can be used to serve the heating or cooling loads of the building of FIG. 1, according to some embodiments.

FIG. 3 is a block diagram of an airside system which can be used to serve the heating or cooling loads of the building of FIG. 1, according to some embodiments.

FIG. 4 is a block diagram of a building management system (BMS) which can be used to monitor and control the building of FIG. 1, according to some embodiments.

FIG. 5 is a block diagram of another BMS which can be used to monitor and control the building of FIG. 1, according to some embodiments.

FIG. 6 is a drawing of a chiller assembly associated with the HVAC system of FIG. 1, according to some embodiments.

FIG. 7 is a block diagram of a sensor health system which can be used in combination with the systems and devices of FIGS. 1-6, according to some embodiments.

FIG. 8 is a plot illustrating a multi-modal distribution which can be generated the sensor health system of FIG. 7, according to some embodiments.

FIG. 9 is a flow diagram of a process for detecting anomalies in a sensor data set and initiating corrective action, according to some embodiments.

FIG. 10 is a flow diagram of a process for training and using mode-specific models to label sensor data as normal or abnormal, according to some embodiments.

FIG. 11 is a flow diagram of a process for training and using a single model to label sensor data as normal or abnormal, according to some embodiments.

### DETAILED DESCRIPTION

### Overview

Referring generally to the FIGURES, systems and methods for detecting abnormalities in sensor data for building equipment are shown, according to some embodiments. In this context, building equipment may include functional equipment that operate to affect a measurable or variable state of a building (e.g., chillers, boilers, lighting equipment, etc.) and/or sensors that monitor the operation of such functional equipment (e.g., vibration sensors, temperature sensors, pressure sensors, etc.) or other variable states or conditions associated with a building (e.g., zone temperature, outdoor air temperature, etc.). The sensor data and analysis thereof can provide an overall indication of whether specific devices of building equipment are functioning properly.

Sensor data analysis is an important tool in identifying mechanical issues in building equipment such as chillers, fans, pumps, etc. In some embodiments sensor data is collected on-site by mounting sensors on, in, or around building equipment. For example, vibration sensors may be placed on a casing of a machine at bearing locations across a machine drive line where forces are transferred from internal components to an external casing. Other types of sensors (e.g., temperature, pressure, flow rate, voltage, etc.) can also or alternatively be used to measure other types of variables or physical conditions of the building equipment to characterize the operation thereof. Sensor data from the sensors can be analyzed using FDD techniques to detect problems with the building equipment or sensors. The sensor data can be assessed to identify potential issues so they can be corrected before serious damage to the building equipment occurs.

Conventional FDD systems typically rely on hard coded rules (e.g., threshold comparisons to minimum or maximum values) to determine whether the data from the sensor is reasonable or accurate. However, hard coded rules have several drawbacks including lack of scalability (i.e., rules can be difficult to manage or generate for new sensors and ranges) and inability to detect subtle changes in operation such as bias or oscillation. In many cases, hard coded rules will represent a larger range of values than is useful to determine erroneous states. For example, a hard coded rule with a minimum and maximum threshold might be used to evaluate performance of the building equipment in multiple different operating states that have different normal characteristics. Such a rule might fail to detect abnormal equipment operation in one state if the detected operation is normal for another state encompassed by the rule. Additionally, conventional FDD systems often are not able to reliable detect bad sensors or distinguish between bad sensors and abnormal equipment operation.

Advantageously, the systems and methods described herein provide a solution that does not have the drawbacks of hard coded rules. Rather, machine learning models are used to automatically establish the normal distributions sensor data and can distinguish between different operating modes of the building equipment. For example, the sensor data from normally operating sensors and equipment may follow known and repetitive multi-modal distributions of data. Each mode of the multi-modal distribution may correspond to a particular operating mode of the building equipment. That is, different distributions of the sensor data may exist for different operating modes or states of the building equipment (e.g., on/off, high/low, single phase vs. multi-phase, etc.). Machine learning can be used to identify the modes in the sensor data and classify the sensor data into different modes. For each mode, the sensor data classified as belonging to that mode can be used to generate a distribution for that mode which indicates the normal values or ranges of the sensor data for that mode. Each distribution may function as a model that represents the normal operation of the building equipment in a given mode.

In operation, the systems and methods described herein may capture a moving window of sensor values from a sensor positioned to monitor a variable state or condition of the building equipment or affected by the building equipment (e.g., temperature, pressure, flow rate, vibration, etc.). In some embodiments, a machine learning model is used to predict the mode of the building equipment when the sensor data was collected (e.g., based on a setpoint, schedule, operating state, or other data values). The actual distribution of the sensor data captured from the moving window is then compared to the expected distribution of the sensor data indicated by the corresponding mode of the building equipment. When the difference between the actual and expected distributions is significant enough (e.g., exceeds a threshold, fails to satisfy a similarity criterion, etc.), either the sensor or the equipment is not working properly and can be identified as faulty. These and other features of the sensor data analysis system are described in greater detail below.

### Building HVAC Systems and Building Management Systems

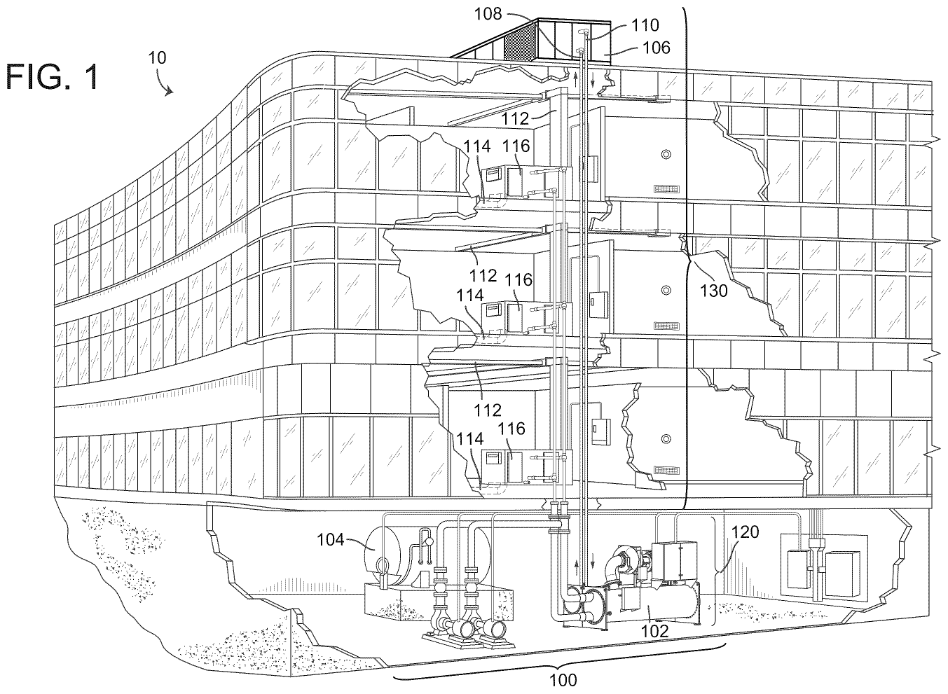

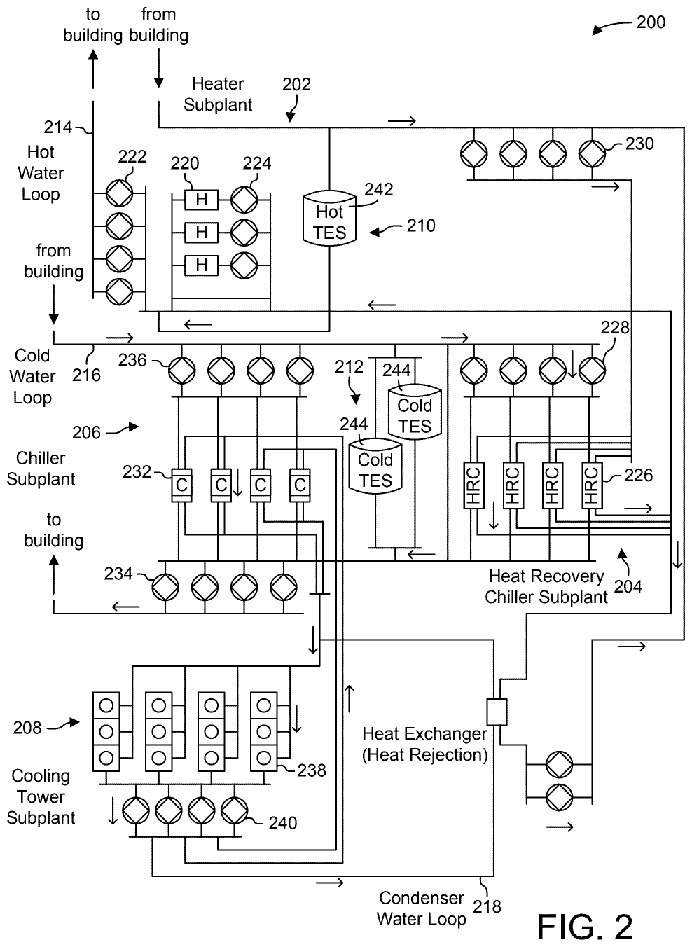

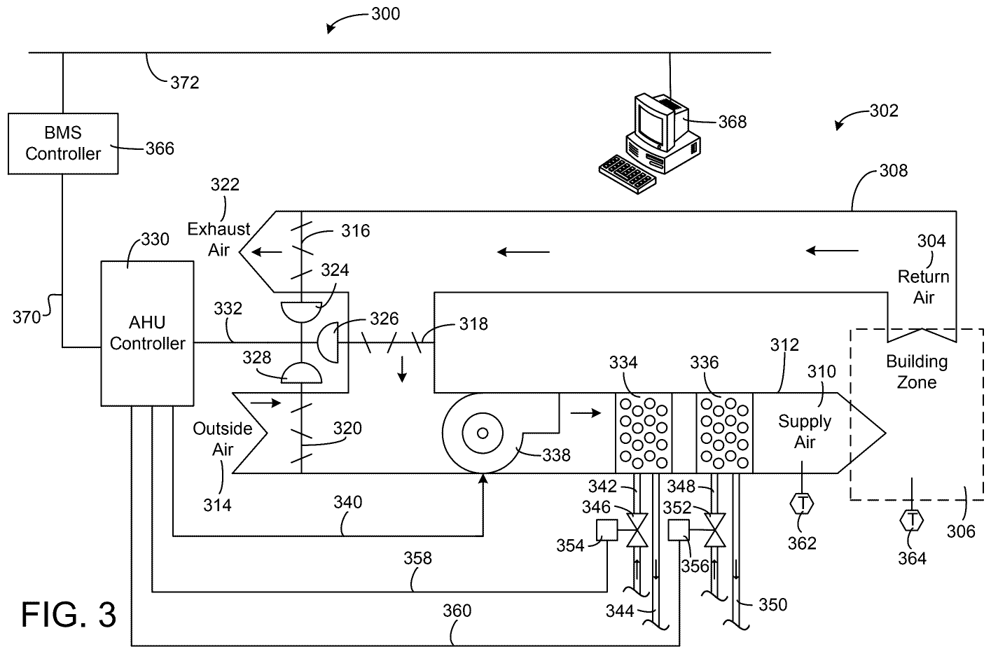

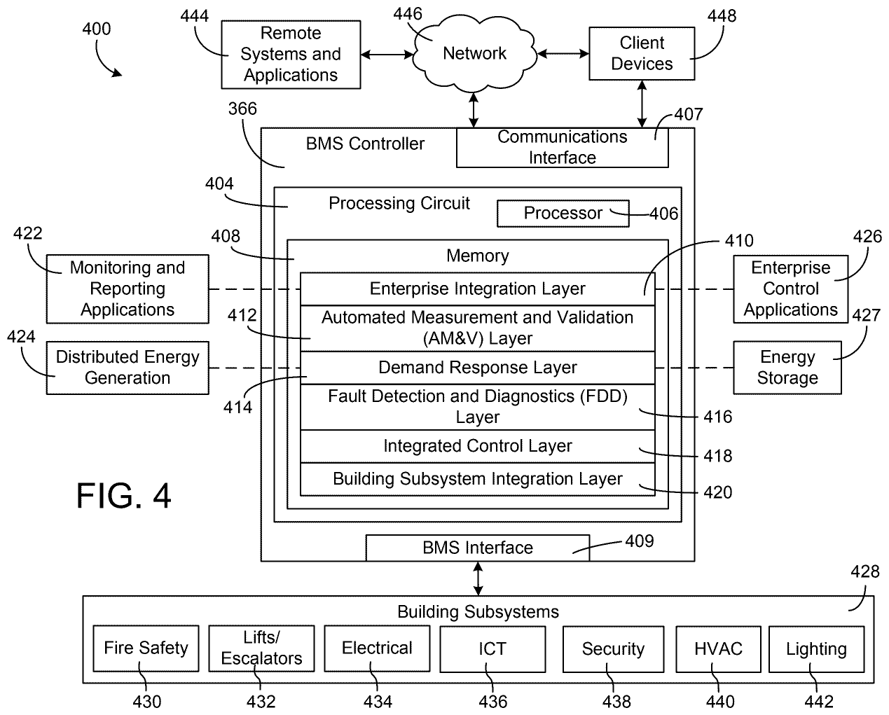

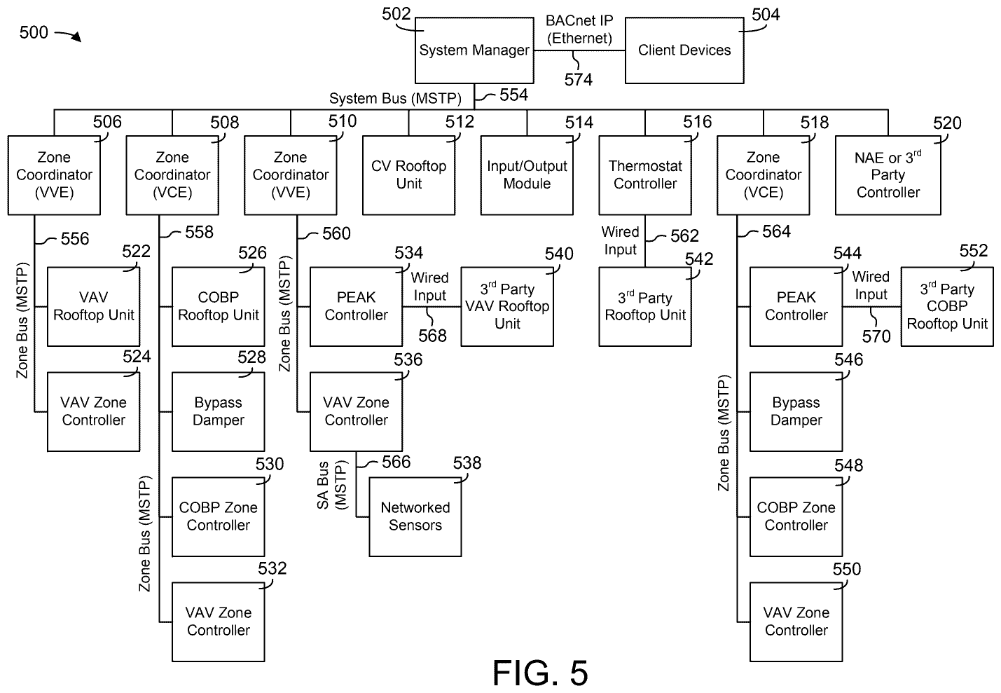

Referring now to FIGS. 1-5, several building management systems (BMS) and HVAC systems in which the systems and methods of the present disclosure can be implemented are shown, according to some embodiments. In brief overview, FIG. 1 shows a building 10 equipped with a HVAC system 100. FIG. 2 is a block diagram of a waterside system 200 which can be used to serve building 10. FIG. 3 is a block diagram of an airside system 300 which can be used to serve building 10. FIG. 4 is a block diagram of a BMS which can be used to monitor and control building 10. FIG. 5 is a block diagram of another BMS which can be used to monitor and control building 10.

### Building and HVAC System

Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

The BMS that serves building 10 includes a HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10. An exemplary waterside system and airside system which can be used in HVAC system 100 are described in greater detail with reference to FIGS. 2-3.

HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 may place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 may transfer heat between the airflow and the working fluid to provide heating or cooling for the airflow. For example, AHU 106 can include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

### Waterside System

Referring now to FIG. 2, a block diagram of a waterside system 200 is shown, according to some embodiments. In various embodiments, waterside system 200 may supplement or replace waterside system 120 in HVAC system 100 or can be implemented separate from HVAC system 100. When implemented in HVAC system 100, waterside system 200 can include a subset of the HVAC devices in HVAC system 100 (e.g., boiler 104, chiller 102, pumps, valves, etc.) and may operate to supply a heated or chilled fluid to AHU 106. The HVAC devices of waterside system 200 can be located within building 10 (e.g., as components of waterside system 120) or at an offsite location such as a central plant.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve thermal energy loads (e.g., hot water, cold water, heating, cooling, etc.) of a building or campus. For example, heater subplant 202 can be configured to heat water in a hot water loop 214 that circulates the hot water between heater subplant 202 and building 10. Chiller subplant 206 can be configured to chill water in a cold water loop 216 that circulates the cold water between chiller subplant 206 building 10. Heat recovery chiller subplant 204 can be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air can be delivered to individual zones of building 10 to serve thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) can be used in place of or in addition to water to serve thermal energy loads. In other embodiments, subplants 202-212 may provide heating and/or cooling directly to the building or campus without requiring an intermediate heat transfer fluid. These and other variations to waterside system 200 are within the teachings of the present disclosure.

Each of subplants 202-212 can include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 may also include one or more pumps or valves configured to control the flow rate of the hot water into or out of hot TES tank 242. Cold TES subplant 212 is shown to include cold TES tanks 244 configured to store the cold water for later use. Cold TES subplant 212 may also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves can be integrated with the pumps or positioned upstream or downstream of the pumps to control the fluid flows in waterside system 200. In various embodiments, waterside system 200 can include more, fewer, or different types of devices and/or subplants based on the particular configuration of waterside system 200 and the types of loads served by waterside system 200.

### Airside System

Referring now to FIG. 3, a block diagram of an airside system 300 is shown, according to some embodiments. In various embodiments, airside system 300 may supplement or replace airside system 130 in HVAC system 100 or can be implemented separate from HVAC system 100. When implemented in HVAC system 100, airside system 300 can include a subset of the HVAC devices in HVAC system 100 (e.g., AHU 106, VAV units 116, ducts 112-114, fans, dampers, etc.) and can be located in or around building 10. Airside system 300 may operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 may receive return air 304 from building zone 306 via return air duct 308 and may deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 can be configured to operate exhaust air damper 316, mixing damper 318, and outside air damper 320 to control an amount of outside air 314 and return air 304 that combine to form supply air 310. Any return air 304 that does not pass through mixing damper 318 can be exhausted from AHU 302 through exhaust damper 316 as exhaust air 322.

Each of dampers 316-320 can be operated by an actuator. For example, exhaust air damper 316 can be operated by actuator 324, mixing damper 318 can be operated by actuator 326, and outside air damper 320 can be operated by actuator 328. Actuators 324-328 may communicate with an AHU controller 330 via a communications link 332. Actuators 324-328 may receive control signals from AHU controller 330 and may provide feedback signals to AHU controller 330. Feedback signals can include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that can be collected, stored, or used by actuators 324-328. AHU controller 330 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 can be configured to force supply air 310 through cooling coil 334 and/or heating coil 336 and provide supply air 310 to building zone 306. AHU controller 330 may communicate with fan 338 via communications link 340 to control a flow rate of supply air 310. In some embodiments, AHU controller 330 controls an amount of heating or cooling applied to supply air 310 by modulating a speed of fan 338.

Cooling coil 334 may receive a chilled fluid from waterside system 200 (e.g., from cold water loop 216) via piping 342 and may return the chilled fluid to waterside system 200 via piping 344. Valve 346 can be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 may receive a heated fluid from waterside system 200 (e.g., from hot water loop 214) via piping 348 and may return the heated fluid to waterside system 200 via piping 350. Valve 352 can be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 can be controlled by an actuator. For example, valve 346 can be controlled by actuator 354 and valve 352 can be controlled by actuator 356. Actuators 354-356 may communicate with AHU controller 330 via communications links 358-360. Actuators 354-356 may receive control signals from AHU controller 330 and may provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 may also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU 330 may control the temperature of supply air 310 and/or building zone 306 by activating or deactivating coils 334-336, adjusting a speed of fan 338, or a combination of both.

Still referring to FIG. 3, airside system 300 is shown to include a building management system (BMS) controller 366 and a client device 368. BMS controller 366 can include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 may communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 can be separate (as shown in FIG. 3) or integrated. In an integrated implementation, AHU controller 330 can be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 may provide BMS controller 366 with temperature measurements from temperature sensors 362-364, equipment on/off states, equipment operating capacities, and/or any other information that can be used by BMS controller 366 to monitor or control a variable state or condition within building zone 306.

Client device 368 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 can be a computer workstation, a client terminal, a remote or local interface, or any other type of user interface device. Client device 368 can be a stationary terminal or a mobile device. For example, client device 368 can be a desktop computer, a computer server with a user interface, a laptop computer, a tablet, a smartphone, a PDA, or any other type of mobile or non-mobile device. Client device 368 may communicate with BMS controller 366 and/or AHU controller 330 via communications link 372.

### Building Management Systems

Referring now to FIG. 4, a block diagram of a building management system (BMS) 400 is shown, according to some embodiments. BMS 400 can be implemented in building 10 to automatically monitor and control various building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2-3.

Each of building subsystems 428 can include any number of devices, controllers, and connections for completing its individual functions and control activities. HVAC subsystem 440 can include many of the same components as HVAC system 100, as described with reference to FIGS. 1-3. For example, HVAC subsystem 440 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 can include any number of light fixtures, ballasts, lighting sensors, dimmers, or other devices configured to controllably adjust the amount of light provided to a building space. Security subsystem 438 can include occupancy sensors, video surveillance cameras, digital video recorders, video processing servers, intrusion detection devices, access control devices and servers, or other security-related devices.

Still referring to FIG. 4, BMS controller 366 is shown to include a communications interface 407 and a BMS interface 409. Interface 407 may facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Interface 407 may also facilitate communications between BMS controller 366 and client devices 448. BMS interface 409 may facilitate communications between BMS controller 366 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 can be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a Wi-Fi transceiver for communicating via a wireless communications network. In another example, one or both of interfaces 407, 409 can include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 can be communicably connected to BMS interface 409 and/or communications interface 407 such that processing circuit 404 and the various components thereof can send and receive data via interfaces 407, 409. Processor 406 can be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 408 can be or include volatile memory or non-volatile memory. Memory 408 can include database components, object code components, script components, or any other type of information structure for supporting the various activities and information structures described in the present application. According to some embodiments, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments BMS controller 366 can be distributed across multiple servers or computers (e.g., that can exist in distributed locations). Further, while FIG. 4 shows applications 422 and 426 as existing outside of BMS controller 366, in some embodiments, applications 422 and 426 can be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 can be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 can be configured to serve clients or local applications with information and services to support a variety of enterprise-level applications. For example, enterprise control applications 426 can be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 366. In yet other embodiments, enterprise control applications 426 can work with layers 410-420 to optimize building performance (e.g., efficiency, energy use, comfort, or safety) based on inputs received at interface 407 and/or BMS interface 409.

Building subsystem integration layer 420 can be configured to manage communications between BMS controller 366 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translate communications (e.g., sensor data, input signals, output signals, etc.) across a plurality of multi-vendor/multi-protocol systems.

Demand response layer 414 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 may receive inputs from other layers of BMS controller 366 (e.g., building subsystem integration layer 420, integrated control layer 418, etc.). The inputs received from other layers can include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to some embodiments, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models can include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 can be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In some embodiments, integrated control layer 418 includes control logic that uses inputs and outputs from a plurality of building subsystems to provide greater comfort and energy savings relative to the comfort and energy savings that separate subsystems could provide alone. For example, integrated control layer 418 can be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 can be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 can be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 can be configured to provide calculated inputs (e.g., aggregations) to these higher levels based on outputs from more than one building subsystem.

Automated measurement and validation (AM&V) layer 412 can be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 can be based on building system energy models and/or equipment models for individual BMS devices or subsystems. For example, AM&V layer 412 may compare a model-predicted output with an actual output from building subsystems 428 to determine an accuracy of the model.

Fault detection and diagnostics (FDD) layer 416 can be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults can include providing an alert message to a user, a maintenance scheduling system, or a control algorithm configured to attempt to repair the fault or to work-around the fault.

FDD layer 416 can be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to some embodiments, FDD layer 416 (or a policy executed by an integrated control engine or business rules engine) may shut-down systems or direct control activities around faulty devices or systems to reduce energy waste, extend equipment life, or assure proper control response.

FDD layer 416 can be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 400 and the various components thereof. The data generated by building subsystems 428 can include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

Referring now to FIG. 5, a block diagram of another building management system (BMS) 500 is shown, according to some embodiments. BMS 500 can be used to monitor and control the devices of HVAC system 100, waterside system 200, airside system 300, building subsystems 428, as well as other types of BMS devices (e.g., lighting equipment, security equipment, etc.) and/or HVAC equipment.

BMS 500 provides a system architecture that facilitates automatic equipment discovery and equipment model distribution. Equipment discovery can occur on multiple levels of BMS 500 across multiple different communications busses (e.g., a system bus 554, zone buses 556-560 and 564, sensor/actuator bus 566, etc.) and across multiple different communications protocols. In some embodiments, equipment discovery is accomplished using active node tables, which provide status information for devices connected to each communications bus. For example, each communications bus can be monitored for new devices by monitoring the corresponding active node table for new nodes. When a new device is detected, BMS 500 can begin interacting with the new device (e.g., sending control signals, using data from the device) without user interaction.

Some devices in BMS 500 present themselves to the network using equipment models. An equipment model defines equipment object attributes, view definitions, schedules, trends, and the associated BACnet value objects (e.g., analog value, binary value, multistate value, etc.) that are used for integration with other systems. Some devices in BMS 500 store their own equipment models. Other devices in BMS 500 have equipment models stored externally (e.g., within other devices). For example, a zone coordinator 508 can store the equipment model for a bypass damper 528. In some embodiments, zone coordinator 508 automatically creates the equipment model for bypass damper 528 or other devices on zone bus 558. Other zone coordinators can also create equipment models for devices connected to their zone busses. The equipment model for a device can be created automatically based on the types of data points exposed by the device on the zone bus, device type, and/or other device attributes. Several examples of automatic equipment discovery and equipment model distribution are discussed in greater detail below.

Still referring to FIG. 5, BMS 500 is shown to include a system manager 502; several zone coordinators 506, 508, 510 and 518; and several zone controllers 524, 530, 532, 536, 548, and 550. System manager 502 can monitor data points in BMS 500 and report monitored variables to various monitoring and/or control applications. System manager 502 can communicate with client devices 504 (e.g., user devices, desktop computers, laptop computers, mobile devices, etc.) via a data communications link 574 (e.g., BACnet IP, Ethernet, wired or wireless communications, etc.). System manager 502 can provide a user interface to client devices 504 via data communications link 574. The user interface may allow users to monitor and/or control BMS 500 via client devices 504.

In some embodiments, system manager 502 is connected with zone coordinators 506-510 and 518 via a system bus 554. System manager 502 can be configured to communicate with zone coordinators 506-510 and 518 via system bus 554 using a master-slave token passing (MSTP) protocol or any other communications protocol. System bus 554 can also connect system manager 502 with other devices such as a constant volume (CV) rooftop unit (RTU) 512, an input/output module (IOM) 514, a thermostat controller 516 (e.g., a TEC5000 series thermostat controller), and a network automation engine (NAE) or third-party controller 520. RTU 512 can be configured to communicate directly with system manager 502 and can be connected directly to system bus 554. Other RTUs can communicate with system manager 502 via an intermediate device. For example, a wired input 562 can connect a third-party RTU 542 to thermostat controller 516, which connects to system bus 554.

System manager 502 can provide a user interface for any device containing an equipment model. Devices such as zone coordinators 506-510 and 518 and thermostat controller 516 can provide their equipment models to system manager 502 via system bus 554. In some embodiments, system manager 502 automatically creates equipment models for connected devices that do not contain an equipment model (e.g., IOM 514, third party controller 520, etc.). For example, system manager 502 can create an equipment model for any device that responds to a device tree request. The equipment models created by system manager 502 can be stored within system manager 502. System manager 502 can then provide a user interface for devices that do not contain their own equipment models using the equipment models created by system manager 502. In some embodiments, system manager 502 stores a view definition for each type of equipment connected via system bus 554 and uses the stored view definition to generate a user interface for the equipment.

Each zone coordinator 506-510 and 518 can be connected with one or more of zone controllers 524, 530-532, 536, and 548-550 via zone buses 556, 558, 560, and 564. Zone coordinators 506-510 and 518 can communicate with zone controllers 524, 530-532, 536, and 548-550 via zone busses 556-560 and 564 using a MSTP protocol or any other communications protocol. Zone busses 556-560 and 564 can also connect zone coordinators 506-510 and 518 with other types of devices such as variable air volume (VAV) RTUs 522 and 540, changeover bypass (COBP) RTUs 526 and 552, bypass dampers 528 and 546, and PEAK controllers 534 and 544.

Zone coordinators 506-510 and 518 can be configured to monitor and command various zoning systems. In some embodiments, each zone coordinator 506-510 and 518 monitors and commands a separate zoning system and is connected to the zoning system via a separate zone bus. For example, zone coordinator 506 can be connected to VAV RTU 522 and zone controller 524 via zone bus 556. Zone coordinator 508 can be connected to COBP RTU 526, bypass damper 528, COBP zone controller 530, and VAV zone controller 532 via zone bus 558. Zone coordinator 510 can be connected to PEAK controller 534 and VAV zone controller 536 via zone bus 560. Zone coordinator 518 can be connected to PEAK controller 544, bypass damper 546, COBP zone controller 548, and VAV zone controller 550 via zone bus 564.

A single model of zone coordinator 506-510 and 518 can be configured to handle multiple different types of zoning systems (e.g., a VAV zoning system, a COBP zoning system, etc.). Each zoning system can include a RTU, one or more zone controllers, and/or a bypass damper. For example, zone coordinators 506 and 510 are shown as Verasys VAV engines (VVEs) connected to VAV RTUs 522 and 540, respectively. Zone coordinator 506 is connected directly to VAV RTU 522 via zone bus 556, whereas zone coordinator 510 is connected to a third-party VAV RTU 540 via a wired input 568 provided to PEAK controller 534. Zone coordinators 508 and 518 are shown as Verasys COBP engines (VCEs) connected to COBP RTUs 526 and 552, respectively. Zone coordinator 508 is connected directly to COBP RTU 526 via zone bus 558, whereas zone coordinator 518 is connected to a third-party COBP RTU 552 via a wired input 570 provided to PEAK controller 544.

Zone controllers 524, 530-532, 536, and 548-550 can communicate with individual BMS devices (e.g., sensors, actuators, etc.) via sensor/actuator (SA) busses. For example, VAV zone controller 536 is shown connected to networked sensors 538 via SA bus 566. Zone controller 536 can communicate with networked sensors 538 using a MSTP protocol or any other communications protocol. Although only one SA bus 566 is shown in FIG. 5, it should be understood that each zone controller 524, 530-532, 536, and 548-550 can be connected to a different SA bus. Each SA bus can connect a zone controller with various sensors (e.g., temperature sensors, humidity sensors, pressure sensors, light sensors, occupancy sensors, etc.), actuators (e.g., damper actuators, valve actuators, etc.) and/or other types of controllable equipment (e.g., chillers, heaters, fans, pumps, etc.).

Each zone controller 524, 530-532, 536, and 548-550 can be configured to monitor and control a different building zone. Zone controllers 524, 530-532, 536, and 548-550 can use the inputs and outputs provided via their SA busses to monitor and control various building zones. For example, a zone controller 536 can use a temperature input received from networked sensors 538 via SA bus 566 (e.g., a measured temperature of a building zone) as feedback in a temperature control algorithm. Zone controllers 524, 530-532, 536, and 548-550 can use various types of control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control a variable state or condition (e.g., temperature, humidity, airflow, lighting, etc.) in or around building 10.

### Chiller Assembly

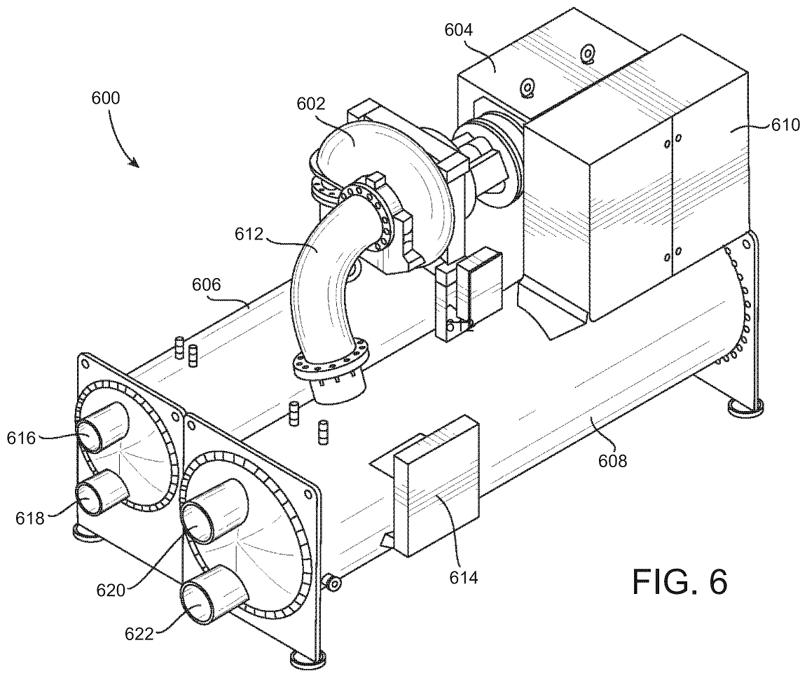

Turning now to FIG. 6, an example implementation of a chiller assembly 600 is shown, according to some embodiments. Chiller assembly 600 is provided as one example of a type of building equipment which can be monitored using the systems and methods described herein. However, it should be understood that the teachings of the present disclosure are not limited to monitoring chillers and can be applied to any type of equipment, such as any of the various types of building equipment described above or any other type of equipment in any other setting (e.g., factory equipment, industrial automation equipment, construction equipment, building equipment, electrical equipment, etc.). The types of sensors which can be used to monitor such equipment can measure any of a variety of variable states or conditions (e.g., temperature, pressure, vibration, flow rate, electric current, voltage, etc.) as may be appropriate to ensure the equipment is operating properly.

Chiller assembly 600 may be the same as or similar to chiller 102 described above. Chiller assembly 600 is shown to include a compressor 602 driven by a motor 604, a condenser 606, and an evaporator 608. A refrigerant can be circulated through chiller assembly 600 in a vapor compression cycle or an absorption refrigeration cycle. The refrigerant can be a low pressure refrigerant with an operating pressure less than 400 kPa, for example. Chiller assembly 600 can also include a control panel 614 configured to control operation of the vapor compression cycle within chiller assembly 600. Control panel 614 may be connected to a variety of sensors (e.g., pressure sensors, temperature sensors) and an electronic network (e.g., network 446) in order to communicate a variety of data related to maintenance, analytics, performance, etc. The sensors may additionally or alternatively communicate directly with a controller (e.g., BMS controller 366) and/or BMS 400.

Motor 604 can be powered by a variable speed drive (VSD) 610. In some embodiments, VSD 610 receives alternating current (AC) power having a fixed line voltage and fixed line frequency from an AC power source (not shown) and provides power having a variable voltage and frequency to motor 604. Motor 604 can be any type of electric motor that can be powered by VSD 610. For example, motor 604 can be a high speed induction motor. Compressor 602 can be driven by motor 604 to compress a refrigerant vapor received from evaporator 608 through a suction line 612. For example, compressor 602 can include an impeller comprising a plurality of blades configured to rotate at a high speed in order to compress refrigerant vapor. Compressor 602 may then deliver compressed refrigerant vapor to condenser 606 through a discharge line. Compressor 602 can be a centrifugal compressor, a screw compressor, a scroll compressor, a turbine compressor, or any other type of suitable compressor.

Evaporator 608 can include an internal tube bundle (not shown), a supply line 620, and a return line 622 for supplying and removing a process fluid to the internal tube bundle. Supply line 620 and return line 622 can be in fluid communication with a component within an HVAC system (e.g., air handler 106) via conduits that circulate the process fluid. In some embodiments, the process fluid is a chilled liquid for cooling a building and can be, but is not limited to, water, ethylene glycol, calcium chloride brine, sodium chloride brine, or any other suitable liquid. Evaporator 608 can be configured to lower the temperature of the process fluid as the process fluid passes through the tube bundle of evaporator 608 and exchanges heat with the refrigerant. Refrigerant vapor is formed in evaporator 608 by the refrigerant liquid delivered to the evaporator 608 exchanging heat with the process fluid and undergoing a phase change to refrigerant vapor.

Refrigerant vapor delivered by compressor 602 to condenser 606 transfers heat to a fluid. Refrigerant vapor condenses to refrigerant liquid in condenser 606 as a result of heat transfer with the fluid. The refrigerant liquid from condenser 606 can flow through an expansion device and be returned to evaporator 608 to complete the refrigerant cycle of the chiller assembly 600. Condenser 606 includes a supply line 616 and a return line 618 for circulating fluid between the condenser 606 and an external component of the HVAC system (e.g., a cooling tower). Fluid supplied to condenser 606 via return line 618 can exchange heat with the refrigerant in condenser 606 and can be removed from the condenser 606 via supply line 616 to complete the cycle. The fluid circulating through the condenser 606 can be water or any other suitable liquid.

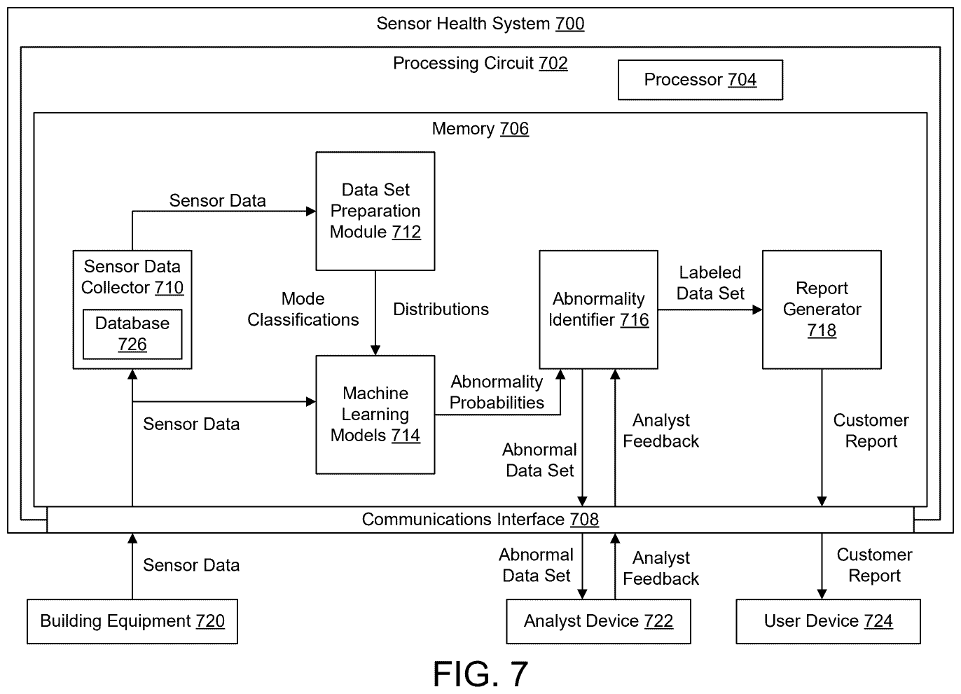

In some embodiments, chiller assembly 600 illustrates an example building device that can be monitored for abnormal data (e.g., vibration data, temperature data, pressure data, etc.). In the case of vibration, vibration sensors can be mounted to an external casing of chiller assembly 600 (e.g., at bearing locations across a drive line of chiller assembly 600). The bearing locations may be locations of chiller assembly 600 that experience transfer of forces to the external casing of chiller assembly 600. Vibration sensors can be mounted to measure three-dimensional vibrational data of chiller assembly 600. In other words, the sensors can measure how chiller assembly 600 and/or associated components vibrate in three-dimensional space. Purely for sake of example, sensors for measuring vibrational data may be mounted at locations of chiller assembly 600 such as motor 604, VSD 610, compressor 602, suction line 612, etc. In this way, vibrational data can be collected across various locations of chiller assembly 600. In the case of temperature, pressure, or other types of measurements (e.g., flow rate, electric current, voltage, etc.), appropriate sensors can be installed at various locations in or on chiller assembly (or other equipment) to monitor the performance thereof. Sensor data collection and processing associated therewith is described in greater detail below with reference to FIGS. 7-11.

### Detecting Anomalies in Sensor Data

Referring generally to FIGS. 7-11, systems and methods for analyzing sensor data and identifying faulty building equipment using machine learning are shown, according to some embodiments. In this context, building equipment may include functional equipment that operate to affect a measurable or variable state of a building (e.g., chillers, boilers, lighting equipment, etc.) and/or sensors that monitor the operation of such functional equipment (e.g., vibration sensors, temperature sensors, pressure sensors, etc.) or other variable states or conditions associated with a building (e.g., zone temperature, outdoor air temperature, etc.). The sensor data and analysis thereof can provide an overall indication of whether specific devices of building equipment are functioning properly.

While the systems and methods of the present disclosure are described primarily in the context of analyzing sensor data for building equipment, it should be understood that the building equipment use case is provided solely for sake of example and is not intended to be limiting. The teachings of the present disclosure can be applied to sensor data associated with any type of equipment and are not limited to building equipment. For example, sensor data can be gathered and analyzed for various other types of equipment such as photolithography equipment, microelectronics manufacturing equipment or other manufacturing equipment, etc. In this way, sensor data can be analyzed to detect faults and/or other problems in various types of equipment. Additionally, the teachings of the present disclosure can be applied to any type of data that characterize operation of equipment or other controllable systems and are not limited to sensor data. For example, other types of data which can be analyzed include timeseries data communicated between equipment controllers and/or other types of equipment (e.g., setpoints, control signals, feedback signals, operating state signals, etc.) or other types of time-varying data which are used by equipment during operation (e.g., tuning parameters, model coefficients, internal equipment state variables, system states, etc.). Timeseries data can be streaming data (e.g., live, real-time, or near real-time data received from a sensor or other device as the data are measured or generated) or historical data (e.g., a timeseries of data values stored in a database). While the following description refers primarily to sensor data for building equipment, it should be understood that the teachings of the present disclosure are not limited to this example use case provided for illustrative purposes.

Sensor data analysis is an important tool in identifying mechanical issues in building equipment such as chillers, fans, pumps, etc. In some embodiments sensor data is collected on-site by mounting sensors on, in, or around building equipment. For example, vibration sensors may be placed on a casing of a machine at bearing locations across a machine drive line where forces are transferred from internal components to an external casing. Other types of sensors (e.g., temperature, pressure, flow rate, voltage, etc.) can also or alternatively be used to measure other types of variables or physical conditions of the building equipment to characterize the operation thereof. Sensor data from the sensors can be analyzed using FDD techniques to detect problems with the building equipment or sensors. The sensor data can be assessed to identify potential issues so they can be corrected before serious damage to the building equipment occurs.

Conventional FDD systems typically rely on hard coded rules (e.g., threshold comparisons to minimum or maximum values) to determine whether the data from the sensor is reasonable or accurate. However, hard coded rules have several drawbacks including lack of scalability (i.e., rules can be difficult to manage or generate for new sensors and ranges) and inability to detect subtle changes in operation such as bias or oscillation. In many cases, hard coded rules will represent a larger range of values than is useful to determine erroneous states. For example, a hard coded rule with a minimum and maximum threshold might be used to evaluate performance of the building equipment in multiple different operating states that have different normal characteristics. Such a rule might fail to detect abnormal equipment operation in one state if the detected operation is normal for another state encompassed by the rule. Additionally, conventional FDD systems often are not able to reliable detect bad sensors or distinguish between bad sensors and abnormal equipment operation.

Advantageously, the systems and methods described herein provide a solution that does not have the drawbacks of hard coded rules. Rather, machine learning models are used to automatically establish the normal distributions sensor data and can distinguish between different operating modes of the building equipment. For example, the sensor data from normally operating sensors and equipment may follow known and repetitive multi-modal distributions of data. Each mode of the multi-modal distribution may correspond to a particular operating mode of the building equipment. That is, different distributions of the sensor data may exist for different operating modes or states of the building equipment (e.g., on/off, high/low, single phase vs. multi-phase, etc.). Machine learning can be used to identify the modes in the sensor data and classify the sensor data into different modes. For each mode, the sensor data classified as belonging to that mode can be used to generate a distribution for that mode which indicates the normal values or ranges of the sensor data for that mode. Each distribution may function as a model that represents the normal operation of the building equipment in a given mode.

In operation, the systems and methods described herein may capture a moving window of sensor values from a sensor positioned to monitor a variable state or condition of the building equipment or affected by the building equipment (e.g., temperature, pressure, flow rate, vibration, etc.). In some embodiments, a machine learning model is used to predict the mode of the building equipment when the sensor data was collected (e.g., based on a setpoint, schedule, operating state, or other data values). The actual distribution of the sensor data captured from the moving window is then compared to the expected distribution of the sensor data indicated by the corresponding mode of the building equipment. When the difference between the actual and expected distributions is significant enough (e.g., exceeds a threshold, fails to satisfy a similarity criterion, etc.), either the sensor or the equipment is not working properly and can be identified as faulty. These and other features of the sensor data analysis system are described in greater detail below.

Referring now to FIG. 7, a block diagram of sensor health system 700 is shown, according to some embodiments. Sensor health system 700 can be configured to analyze sensor data sets (or other types of data sets such as setpoints, control signals, etc.) to determine if the data sets include abnormalities that may be indicative of problems with building equipment 720 (e.g., sensors, chillers, boilers, fans, pumps, lighting equipment, etc.). In some embodiments, sensor health system 700 can use machine learning (ML) models 714 to qualify data sets as either normal or abnormal such that appropriate corrective action can be taken to repair or replace any faulty building equipment. As described in greater detail below, sensor health system 700 can provide various benefits for a building system and employees associated therewith.

In some embodiments, sensor health system 700 can be implemented as a component of a building management system (BMS) such as BMS 400 or BMS 500 as described with reference to FIGS. 4-5 (e.g., as part of FDD layer 416). Sensor health system 700 can be located on-site (e.g., in the same building or campus as building equipment 720, within building 10, etc.) or off-site (e.g., at a remote location, a remote monitoring system, etc.) in various embodiments. For example, sensor health system 700 can be implemented as part of a centralized controller for the building or site (e.g., as part of BMS controller 366 or system manager 502) or as part of an edge device (e.g., a field controller, a gateway, a device of controllable equipment, etc.). In some embodiments, sensor health system 700 is implemented as part of a cloud-hosted suite of building management applications or services which communicates with building equipment 720 via a communications network such as the internet, a cellular network, a WAN, etc. It is contemplated that sensor health system 700 can be implemented in any location and can be centralized or distributed in various architectures. For example, some components of sensor health system 700 may be located on-site, whereas other components of sensor health system 700 may be located off-site in a distributed implementation. In some embodiments, various components of sensor health system 700 can be distributed across multiple on-site or off-site devices (e.g., a centralized BMS, edge devices or gateways, supervisory or field controllers, etc.). The location or locations of sensor health system 700 is not important and can be varied to accommodate a variety of implementation architectures.

Sensor health system 700 is shown to include a communications interface 708 and a processing circuit 702. Communications interface 708 may include wired or wireless interfaces (e.g., jacks, antennas, transmitters, receivers, transceivers, wire terminals, etc.) for conducting data communications with various systems, devices, or networks. For example, communications interface 708 may include an Ethernet card and port for sending and receiving data via an Ethernet-based communications network and/or a Wi-Fi transceiver for communicating via a wireless communications network. Communications interface 708 may be configured to communicate via local area networks or wide area networks (e.g., the Internet, a building WAN, etc.) and may use a variety of communications protocols (e.g., BACnet, IP, LON, etc.). Communications interface 708 may be a network interface configured to facilitate electronic data communications between sensor health system 700 and various external systems or devices (e.g., building equipment 720, analyst device 722, user device 724, etc.). For example, sensor health system 700 may receive sensor data sets from building equipment 720 via communications interface 708.

Processing circuit 702 is shown to include a processor 704 and memory 706. Processor 704 may be a general purpose or specific purpose processor, an application specific integrated circuit (ASIC), one or more field programmable gate arrays (FPGAs), a group of processing components, or other suitable processing components. Processor 704 may be configured to execute computer code or instructions stored in memory 706 or received from other computer readable media (e.g., CDROM, network storage, a remote server, etc.). Although only one processing circuit 702 and one processor 704 are shown in FIG. 7, it is contemplated that sensor health system 700 can include one or more processing circuits 702 one or more processors 704 in various embodiments.

Memory 706 may include one or more devices (e.g., memory units, memory devices, storage devices, etc.) for storing data and/or computer code for completing and/or facilitating the various processes described in the present disclosure. Memory 706 may include random access memory (RAM), read-only memory (ROM), hard drive storage, temporary storage, non-volatile memory, flash memory, optical memory, or any other suitable memory for storing software objects and/or computer instructions. Memory 706 may include database components, object code components, script components, or any other type of information structure for supporting the various activities and information structures described in the present disclosure. Memory 706 may be communicably connected to processor 704 via processing circuit 702 and may include computer code for executing (e.g., by processor 704) one or more processes described herein. In some embodiments, one or more components of memory 706 are part of a singular component. However, each component of memory 706 is shown independently for ease of explanation.

Memory 706 is shown to include a sensor data collector 710. Sensor data collector 710 can be configured to receive sensor data sets from building equipment 720 (e.g., via communications interface 708). Building equipment 720 can include any equipment that operates to affect a variable state or condition of a building and/or other space. Specifically, building equipment 720 can operate to affect environmental conditions of the building and/or other space. As such, building equipment 720 may include, for example, chillers, boilers, air handling units, fire suppression equipment, etc. In some embodiments, building equipment 720 includes some and/or all of the subsystems of building subsystems 428 as described with reference to FIG. 4. In some embodiments, building equipment 720 include various types of sensors (e.g., vibration sensors, temperature sensors, pressure sensors, etc.) configured to monitor the performance of building equipment 720. Such sensors can be affixed to devices of building equipment 720 and/or otherwise capable of obtaining measurements of building equipment 720.

The sensor data sets collected by sensor data collector 710 may include timeseries of measurements from one or more sensors over a window of time. Each measurement or sample of the sensor data may correspond to a particular sensor and may include a measurement value (e.g., a value of temperature, pressure, or any other variable the sensor is configured to measure) and a time stamp indicating a time at which the sample was collected. For example, the sensor data from a temperature sensor may include a series of temperature measurements, each including a measured temperature value and a time stamp. As another example, the sensor data from a vibration sensor may include timewave data indicating acceleration over time. Various types of sensor data including vibration data sets and other types of sensor data are described in detail in U.S. patent application Ser. No. 15/993,331 filed May 30, 2018, U.S. patent application Ser. No. 16/413,892 filed May 16, 2019, and U.S. patent application Ser. No. 16/658,822 filed Oct. 21, 2019, the entire disclosure of each of which is incorporated by reference herein. In some embodiments, the systems and methods described herein can be implemented in combination with the systems and methods described in the incorporated patent applications.

In some embodiments, the sensor data include other information such as equipment metadata (e.g., the name, ID, or type of equipment from which the sensor data was collected), equipment operating conditions (e.g., the operating mode or state of the building equipment when the sensor data was collected), one or more time waveforms, relevant equipment specifications (e.g., a type of chiller or pump, a number of impeller blades, a gear ratio, etc.), or any other information which provides context for the sensor data. Additional information other than raw measurement signals can help data set abnormality controller 700 in determining the appropriate mode of the sensor data or otherwise classify the sensor data (e.g., as belonging to a particular sensor or device of building equipment 720, characterizing a particular mode of operation of building equipment 720, etc.).

In some embodiments, sensor data collector 710 stores collected sensor data in a database 726. Database 726 is shown as a component of sensor data collector 710 for ease of explanation, but may be a separate component of sensor health system 700 and/or may be separate from sensor health system 700 altogether in various other embodiments. For example, database 726 may be hosted by a cloud provider and hosted on a cloud computation system that sensor health system 700 can communicate with. In this case, sensor data collector 710 may transmit and receive sensor data sets to and from the cloud computation system via communications interface 708. In any case, by storing sensor data sets in database 726, the sensor data sets can be saved and later used for other processes such as retraining ML models 714 for detecting abnormalities, displaying sensor data sets to analysts, etc.

Sensor data collector 710 can provide sensor data sets to data set preparation module 712. Data set preparation module 712 can prepare sensor data sets for being used as input to ML models 714. Dependent on a format of ML models 714 and/or the sensor data, some ML models of ML models 714 may require sensor data to be presented as input in a format other than raw measurement signals. For example, if the sensor data are vibrational data including raw timewaves, data set preparation module 712 may convert the raw timewaves into spectral data (e.g., by performing fast Fourier transforms (FFTs) on the raw timewaves). Examples of FFT processes which can be performed by data set preparation module 712 are described in greater detail in U.S. patent application Ser. No. 16/658,822 filed Oct. 21, 2019, the entire disclosure of which is incorporated by reference herein. As such, data set preparation module 712 can manipulate sensor data sets received from sensor data collector 710 to ensure data provided to ML models 714 is in a proper format and includes useful information.

In some embodiments, data set preparation module 712 labels or classifies the sensor data into various modes. Each mode may correspond to a particular state or operating mode of the equipment (e.g., on, off, high, low, single-stage, multi-stage, startup, steady state, shutdown, etc.) during which the sensor data were collected. For example, a first portion of the sensor data collected from a chiller temperature sensor during startup of the chiller may be classified into a first mode, whereas a second portion of the sensor data collected from the same chiller temperature sensor when the chiller was operating at steady state (e.g., after startup) may be classified into a second mode.

Data set preparation module 712 can classify the sensor data using any of a variety of techniques. In some embodiments, data set preparation module 712 uses metadata included in the sensor data to identify the operating mode or state of the equipment when the sensor data was collected. Such information may be explicitly indicated by the metadata or can be inferred or determined by comparing information in the metadata to other data values. For example, time stamps in the sensor data can be compared to information indicating the operating modes or operating states of building equipment 720 at various times to determine the operating mode of building equipment when each sample of the sensor data was collected. In some embodiments, data set preparation module 712 uses a classification model such as a ML model to classify the sensor data. The classification model can include one or more of ML models 714 or different ML models trained to classify the sensor data into various modes. In some embodiments, the classification model is based on the operating states of building equipment 720 and uses a set of rule to determine the mode based on the operating states (e.g., based on operating states of building equipment 720 at the time the sensor data is collected or generated).

In some embodiments, data set preparation module 712 generates a distribution of the sensor data for each mode. Each distribution may be specific to a corresponding mode of the sensor data and may include, for example, a probability distribution (e.g., a probability density) of the sensor data values for the corresponding mode. In some embodiments, data set preparation module 712 generates the probability distribution for a given mode of the sensor data by counting the number of data samples of the sensor data that fall within various ranges of measured values. The percentage or proportion of the sensor data samples that fall within each range indicates the density of that range in the set of sensor data for the corresponding mode. Data set preparation module 712 may repeat the distribution generation process for each mode into which the sensor data were classified. For building equipment 720 which have multiple operating modes, this may result in a multi-modal distribution (i.e., a distribution that contains multiple different mode-specific distributions). Each mode-specific distribution of the multi-modal distribution may correspond to a particular operating mode of building equipment and represents the distribution of the sensor data values for that operating mode.

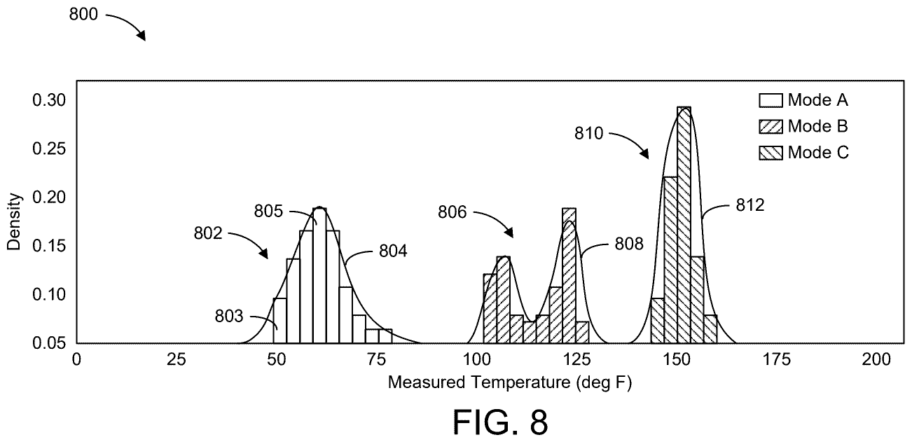

Referring now to FIG. 8, a plot 800 illustrating a multi-modal distribution which can be generated by data set preparation module 712 is shown, according to an exemplary embodiment. The data shown in plot 800 are based on measurements from a temperature sensor positioned to measure temperature at a particular location on a device of building equipment 720. Sensor data collector 710 can collect a set of temperature measurements from the temperature sensor over a time window as discussed above and provide the temperature measurements to data set preparation module 712 along with any accompanying metadata. While temperature measurements are shown in plot 800 as one example of sensor data, it should be understood that the sensor data can measure any type of variable depending on the type of sensor and/or building equipment 720.

Data set preparation module 712 can classify each sample of the sensor data into a mode based on the conditions under which the sample was collected. The modes are shown in plot 800 as three modes (i.e., Mode A, Mode B, and Mode C) but could include any number of modes in various embodiments, depending on the characteristics of the sensor data and/or building equipment 720. For example, if the temperature measurements are collected from a multi-stage chiller, Mode A could correspond to a startup mode of the chiller, Mode B could correspond to steady state chiller operation using a single stage of the chiller (i.e., single stage mode), and Mode C could correspond to steady state chiller operation using multiple stages of the chiller (i.e., multi-stage mode). In some embodiments, data set preparation module 712 uses a classification model (e.g., a ML classifier) to classify each sample of the sensor data to a particular mode.

For each mode of the sensor data, data set preparation module 712 can generate a distribution of the sensor data based on the measured values of the sensor data for that mode. In plot 800, the distributions are shown as distribution 802 for Mode A, distribution 806 for Mode B, and distribution 810 for Mode C. Each distribution 802, 806, and 810 is shown to include several bars. The width of each bar corresponds to a temperature range of approximately 3° F. For example, the left-most bar 803 of distribution 802 corresponds to a temperature range between approximately 50° F. and 53° F., whereas the tallest bar 805 of distribution 802 corresponds to a temperature range between approximately 59° F. and 62° F. The height of each bar indicates the density (i.e., the probability or proportion) of the sensor data values within a given mode that fall into the corresponding temperature range. For example, the left-most bar 803 of distribution 802 has a density of approximately 0.1 which indicates that approximately 10% of the sensor data values classified into Mode A are between 50° F. and 53° F. Similarly, the tallest bar 805 of distribution 802 has a density of approximately 0.2 which indicates that approximately 20% of the sensor data values classified into Mode A are between 59° F. and 62° F. Data set preparation module 712 can process the sensor data for each mode and generate a mode-specific distribution for each mode.

In some embodiments, data set preparation module 712 generates a continuous probability density function (PDF) for each mode. In plot 800, the PDFs are shown as PDF 804 for Mode A, PDF 808 for Mode B, and PDF 812 for Mode C. Data set preparation module 712 may generate the PDFs 804, 808, and 812 by fitting a continuous function to each of the distributions 802, 806, and 810, respectively, or using any other statistical technique known in the art for generating continuous PDFs from a set of data values. The area under each PDF 804, 808, and 812 roughly aligns with the area encompassed by the bars of each distribution 802, 806, and 812. The integral of each PDF 804, 808, and 812 over a given temperature range (i.e., the area under the curve of each PDF 804, 808, and 812 within that temperature range) represents the probability that a sample of the sensor data for the corresponding mode will fall within that same temperature range.

Referring again to FIG. 7, the mode classifications and distributions generated by data set preparation module 712 can be provided as input to one or more machine learning (ML) models 714. During a training phase of sensor health system 700, data set preparation module 712 can classify each sample of the sensor data into a mode and generate a distribution for each mode as described above. The sensor data collected during the training phase are referred to herein as training data. Sensor health system 700 can use the distributions for the various modes to train ML models 714. In some embodiments, ML models 714 include a ML model for each mode/distribution represented in the sensor data. Each mode-specific ML model can be trained using the distribution for that mode to determine whether a given sample of sensor data is normal or abnormal for the corresponding mode. In other embodiments, ML models 714 include a single ML model trained using multiple distributions for multiple different modes. In this scenario, a single ML model 714 can be configured to determine whether a given sample of sensor data is normal or abnormal for each of the multiple different modes.

Before discussing ML models 714 in detail, it should be noted that although ML models 714 are described primarily as machine learning models, it is contemplated that any type of model (i.e., machine learning or non-machine learning) can be used in place of machine learning models. For example, ML models 714 can be substituted or supplemented with rules-based models, statistical models, decision tree models, binary classification models, Naive Bayes models, K-Nearest Neighbor (KNN) models, regression models, Support Vector Machine (SVM) models, or any other type of model which can be used to determine whether a given sample or distribution of sensor data is normal or abnormal with respect to one or more modes of building equipment 720, without departing from the teachings of the present disclosure. The following description refers to ML models 714 primarily as machine learning models for ease of explanation, but it should be understood that the systems and methods described herein are not limited to machine learning models.

After ML models 714 are trained during the training phase, sensor health system 700 can use ML models 714 during an operational phase of sensor health system 700. During the operational phase, new samples of the sensor data can be collected from building equipment 720 and provided as input to both data set preparation module 712 and ML models 714. Data set preparation module 712 can classify each new sample of the sensor data into a mode using the same or similar techniques used to classify the sensor data during the training phase (e.g., using a classification model, using a ML model, etc.). The mode classifications of the new sensor data can be provided as another input to ML models 714 and used to determine whether the new sensor data are normal or abnormal for the mode or modes into which the sensor data are classified.

In some embodiments, ML models 714 process each new sample of the sensor data individually and determine whether that sample of sensor data is normal or abnormal for one or more of the modes. For example, consider a scenario in which a given sample of sensor data has a measured value of 120° F. and is classified into Mode A shown in plot 800. In this case, ML models 714 may determine that the sample of sensor data is highly abnormal for Mode A because distribution 802 for Mode A extends from approximately 50° F. to 75° F. and PDF 804 for Mode A has a near-zero density value at 120° F. However, ML models 714 may determine that the same sample of sensor data is normal for Mode B because distribution 806 for Mode B extends from approximately 100° F. to 125° F. and PDF 808 for Mode B has a density value of approximately 0.20 at 120° F.

In some embodiments, ML models 714 process multiple new samples of the sensor data concurrently by determining whether a given distribution of the new sensor data is similar or dissimilar to the distributions generated during the training phase. For example, for a new window of the sensor data collected during the operational phase, data set preparation module 712 may generate one or more distributions of the new sensor data using the same or similar techniques used during the training phase. Each distribution may correspond to a particular mode and may be generated using the samples of new sensor data classified into that mode by data set preparation module 712. Data set preparation module 712 can provide the distributions generated for the new sensor data to ML models 714. ML models 714 can compare the new distributions generated for the new sensor data against the distributions generated from the training data to determine whether the new distributions of the sensor data are normal or abnormal relative to the distributions generated using the training data.

For example, consider a scenario in which a chiller is turned on at the beginning of the operational phase. The chiller operates in Mode A (e.g., startup mode) for a first portion of the operational phase, operates in Mode B (e.g., steady state single-stage mode) for a second portion of the operational phase, and operates in Mode C (e.g., steady state dual-stage mode) for a third portion of the operational phase. Data set preparation module 712 can classify each sample of the new sensor data into either Mode A, Mode B, or Mode C and generate a distribution for each mode using the subsets of sensor data classified into the corresponding mode. ML models 714 can compare the newly generated distribution for Mode A against the stored distribution generated for Mode A based on the training data. Similarly, ML models 714 can compare the newly generated distribution for Mode B against the stored distribution generated for Mode B based on the training data, and can compare the newly generated distribution for Mode C against the stored distribution generated for Mode C based on the training data. Each comparison may include, for example, determining how closely the newly generated distribution matches the stored distribution for the corresponding mode. Based on these comparisons, ML models 714 can determine whether the newly collected sensor data is normal or abnormal for each mode.

ML models 714 can include one or more ML models that can determine probabilities that a sensor data set includes at least one abnormality based on the distributions generated by data set preparation module 712. For example, an ML model of ML model 714 may predict that a first sensor data set has a 30% probability of including an abnormality whereas a second sensor data set has a 70% probability of including an abnormality. In some embodiments, ML models 714 output a different indicator of abnormalities in sensor data sets. For example, an ML model of ML models 714 may output a binary decision (e.g., yes or no) indicating whether or not the ML model predicts that a sensor data set includes an abnormality.

In some embodiments, ML models 714 are configured to predict a value or distribution of sensor data that is normal (e.g., normal for a given mode) based on the distributions generated for each mode by data set preparation module 712. For example, the current mode of building equipment 720 can be provided as an input to ML models 714 and used to predict a normal value or distribution of the sensor data for that mode. The predicted values or distributions generated by ML models 714 can then be compared against the actual values or distributions of the sensor data received from building equipment 720 to determine whether the sensor data are normal or abnormal. For example, if the actual value of a sample of the sensor data differs from the predicted value of the sensor data generated by ML models 714 by more than a threshold, ML models 714 may determine that the actual sample of sensor data is abnormal. Similarly, if the actual distribution of the sensor data differs from the predicted distribution of the sensor data generated by ML models 714 by more than a threshold, ML models 714 may determine that the actual distribution of sensor data is abnormal. In some embodiments, ML models 714 assign an abnormality probability to each sample or distribution of the sensor data based on the difference between the predicted value of the sensor data sample/distribution and the actual value of the sensor data sample/distribution, where larger differences correspond to larger abnormality probabilities.

Advantageously, ML models 714 can provide additional information for analysts to consider if evaluating machine health of building equipment 720. Insight provided by ML models 714 may include predicted health scores for specific equipment components, a determination of important machine speeds, highlighting particular samples of the sensor data or regions of the distributions that need attention, etc. In this way, analyst efficiency in analyzing sensor data sets can increase by providing additional information beyond raw sensor data.

ML models 714 can also assess a condition of an entire device of building equipment 720 and indicate whether the device is functioning normally, or if the device is potentially abnormal and should be evaluated by a human analyst. In this way, ML models 714 can eliminate some sensor data sets from needing to be analyzed by an analyst, thereby increasing efficiency of the analyst. In some embodiments, if enough data is available, ML models 714 can be trained to automatically and accurately diagnose faulty building equipment 720. However, if accuracy of all decisions is of high priority (e.g., to a user), some and/or all sensor data sets identified as being potentially abnormal may be evaluated by human analysts to ensure that diagnoses of equipment problems are accurate.

ML models 714 may include a variety of ML models generated for various building devices of building equipment 720. For example, ML models 714 may include ML models for identifying/predicting abnormalities in sensor data sets for chillers, pumps, fans, etc. Generating models for different building equipment may be important if multiple devices are analyzed as certain devices may be associated with different distributions of sensor data compared to others. In other words, a normal distribution or range of sensor data for one building device may not be the same for a separate building device (e.g., a normal temperature distribution for a chiller may not be the same as for a boiler). As such, each building device and/or building device type can have a separate ML model for analyzing sensor data. In any case, an ML model of ML models 714 can evaluate sensor data collected from a building device and determine whether any of the sensor data and/or distributions of sensor data for the building device are abnormal. Results from individual distributions and/or individual samples of the sensor data be aggregated to determine whether the entire dataset may be abnormal. In this way, output of ML models 714 can be used to filter out sensor data sets that are “normal” and do not need to be evaluated by a human analyst. In some embodiments, ML models 714 further detect specific types of faults or machine malfunctions, as opposed to generic abnormalities.

In some embodiments, the ML models of ML models 714 are convolutional neural networks (CNNs). CNNs can be useful particularly problems where local relationships within input data are important (e.g., image classification tasks). In other words, CNNs can be useful in cases where repeating patterns exist throughout a sample input. While analysis of sensor data and/or distributions may be complex, signatures of abnormal equipment function can often be detected visually in the density spectrum domain (i.e., the domain of the density distributions and/or PDFs generated by data set preparation module 712). As such, CNN models can be utilized to identify abnormal sensor signals can reliably automate a portion of sensor data analysis. As described above, reduction in a number of data sets manually analyzed by analysts can allow the analysts to focus on suspected abnormal equipment and thus accommodate a larger volume of data. In terms of ML models 714, the CNNs may be used to classify one-dimensional inputs.

CNNs can include convolutional layers, activation layers, pooling layers, and fully connected layers. A convolutional layer can include a number of filters that can learn different features from an input. With specific regard to ML models 714, the filters may learn to recognize, for example, distribution peaks and peak patterns, regardless of whether they appear in input. Convolutional layers may result in parameter sharing as peaks and spectral patterns may repeat throughout a distribution spectrum sample.

Activation layers of CNNs can apply an activation function to their inputs. With regards to CNNs of ML models 714, the CNNs can utilize rectified linear unit (ReLU) activation layers why can apply the following activation function:

$$f ( x ) = max ( 0 , x )$$

where x is some input value.

Pooling layers of CNNs can downsample their input to decrease a complexity of the CNN model. Specifically, downsampling can reduce a number of parameters of the CNN model. For example, pooling layers may take maximum values across small regions of the input to reduce a number of variables across each small region to one (i.e., the maximum value).

Fully connected layers of CNNs can operate as ordinary neural networks and can be used at the end of a CNN to output a final class score. In this way, the fully connected layers can output abnormality probabilities based on the sensor data distributions received from data set preparation module 712.

Each of the CNN models of ML models 714 can evaluate one of the distributions provided by data set preparation module 712. Machine specifications and other metadata characterizing the collected sensor data (e.g., operating mode of building equipment 720 at the time the sensor data are collected) can be incorporated in the final layers of each model. CNN models can be trained on labeled historical data that is available (e.g., stored in database 726) so that the CNN models output a probability that a given distribution is abnormal (i.e., is indicative of a machine fault). In some embodiments, the CNN models further predict a specific type of machine fault that is present based on the sensor data distributions. For example, the CNN models may learn to associate certain distribution patterns with specific component failures.

To achieve good performance of abnormality predictions, CNN models of ML models 714 may require a large amount of training data. However, obtaining a large number of labeled sensor data sets may not feasible for all equipment types, and so, data availability may be a limiting factor for extending the anomaly detection models. To mitigate data availability problems, the CNN models may be trained using transfer learning. With transfer learning, an ML model can be trained on one set of data and then applied to a separate set of data for which there may be significantly less data. The ML model can be fine-tuned on the new set of data, but the performance is helped significantly by what the ML model learns from the first set of data. Transfer learning may work especially well if fundamental features the CNN learns (e.g., FFT peaks) are the same for the two data sets.

As an example of transfer learning that can be used in training the CNNs, a CNN model for a first chiller type may be trained based at least partially on sensor data sets for a second chiller type. In this case, the CNN model can be trained based on the sensor data sets and/or CNN models for the second chiller type and fine-tuned based on sensor data sets for the first chiller type. Specifically, the CNN model can be initially trained based on the sensor data sets for the second chiller type. Some of the learned weights of the CNN model can be fixed prior to fine-tuning based on sensor data sets for the first chiller type. In this case, a number of layers of the CNN model that are fixed can be configurable by testing what layers being fixed results in the best performance. In this way, the CNN model can be trained to predict abnormalities in sensor data sets for the first chiller type using data for the second chiller type.

It should be appreciated that CNNs are given purely for sake of example. The ML models of ML models 714 can be based on any appropriate type of machine learning model that can be used to classify sensor data sets as abnormal or normal with respect to one or more distributions or modes of the sensor data. For example, ML models 714 may include long short-term memory (LSTM) models, other recurrent neural networks, etc. Dependent on a type of ML model used, data set preparation module 712 may or may not be included in sensor health system 700. Further, data set preparation module 712 may perform other operations as opposed to and/or in addition to classifying sensor data into modes and generating distributions. In this sense, data set preparation module 712 can be configured and customized to prepare data in a format that can be used as input by ML models 714.

In some embodiments, ML models 714 are optimized for recall (a percentage of faulty machines ML models 714 are able to detect) or precision (a percentage of building devices that ML models 714 classify as faulty that are actually faulty). As ML models 714 catch more fault (i.e., recall increases), a higher number of “false alarms” (i.e., building devices identified as faulty that are operating normally) may increase as well. In other words, as recall increases, precision may decrease and vice-versa.

Model performance of ML models 714 can be tuned by adjusting a probability threshold used to assign normal and abnormal labels to sensor data sets. A higher threshold may result in lower recall and fewer false positives, whereas a lower threshold may achieve high recall (e.g., near 100% recall) but may have more false positives. If a goal of a user and/or sensor health system 700 is to catch as many equipment faults as possible (i.e., near-100% recall) and ensure no critical faults are missed by ML models 714, the probability threshold may be lowered to a value that helps decrease a probability of missed equipment faults. However, the probability threshold may be required to be over a predetermined minimum value (e.g., 10%, 20%, 50%, etc.) such that a number of sensor data sets manually analyzed by analysts is reduced. If an extremely low probability threshold is used (e.g., 0%, 1%, etc.), a large number of sensor data sets that can be safely classified as normal may be unnecessarily qualified as abnormal, thereby increase a workload on analysts. In other words, the probability threshold should be set (e.g., by a user, by sensor health system 700, etc.) such that a number of “acceptable” data sets (i.e., data sets that do not indicate a fault) classified as normal by ML models 714 is maximized while a number of non-acceptable data sets (i.e., data sets that indicate a fault) classified as normal by ML models 714 is minimized.

In some embodiments, the probability threshold is selected respective to types of equipment faults that can occur. For example, equipment faults may be classified as either “alert” faults (i.e., minor faults) or “alarm”/“danger” faults (i.e., critical faults). In this case, alert faults may indicate some fault that may, for example, raise operational costs, but would not be catastrophic to a system if left unaccounted for. Alarm/danger faults, however, may indicate equipment faults that, if left unaccounted for, may result in very large increases in operational costs, system failure, and/or other significant outcomes for a system. Based on the equipment fault classifiers, the probability threshold for ML models 714 can be set respective of the classifiers. For example, a conservative probability threshold may be set such that effectively no alert faults or alarm/danger faults are misclassified as normal. As another example, a less conservative probability threshold for ML models 714 may be set such that a few alert faults may be misclassified but that no alarm/danger fault are misclassified. In some embodiments, the probability threshold is automatically adjusted by sensor health system 700 based on feedback about misclassifications from a user and based on a tolerance for misclassified faults and false positives set by the user (or some other entity).

As a result of passing individual samples of sensor data and/or distributions of sensor data for a sensor data set through ML models 714, a set of abnormality probabilities for the sensor data set can be calculated and provided to an abnormality identifier 716. For a given sensor data set, a specific ML model associated with a distribution or mode of the sensor data can analyze the sensor data to determine a probability that the sensor data are abnormal for the associated distribution or mode. This process can be repeated for each distribution or more of the sensor data set such that abnormality identifier 716 can receive an abnormality probability for each distribution or mode of the sensor data.

Based on a received set of abnormality probabilities for a sensor data set, abnormality identifier 716 can identify/determine whether the sensor data set is abnormal. Abnormality identifier 716 can identify whether the sensor data set is normal or abnormal through a variety of methods. In some embodiments, abnormality identifier 716 determines whether a given set of sensor data collected during the operational phase of sensor health system 700 is normal or abnormal for each of the distributions generated during the training phase of sensor health system 700. For example, if the distributions generated during the training phase include three distributions (e.g., distributions 802, 806, and 810 shown in plot 800), abnormality identifier 716 may determine whether a new set of sensor data collected during the operational phase is normal or abnormal with respect to each of the three distributions. In some cases, abnormality identifier 716 may determine that the new set of sensor data is normal with respect to one or more of the distributions but abnormal with respect to one or more of the other distributions.

In some embodiments, abnormality identifier 716 determines whether the new set of sensor data is normal or abnormal based on the mode or modes into which the new set of sensor data is classified by data set preparation module 712. For example, if data set preparation module 712 classifies the new set of sensor data gathered during the operational phase of sensor health system 700 into Mode A, abnormality identifier 716 may determine whether the new set of sensor data is normal or abnormal with respect to Mode A (e.g., based on the abnormality probability generated by ML models 714 by comparing the new set of sensor data to the distribution 802 for Mode A). However, if data set preparation module 712 classifies the new set of sensor data into Mode B, abnormality identifier 716 may determine whether the new set of sensor data is normal or abnormal with respect to Mode B (e.g., based on the abnormality probability generated by ML models 714 by comparing the new set of sensor data to the distribution 806 for Mode B). Abnormality identifier 716 can determine whether the abnormality probability of the new sensor data with respect to the distribution into which the sensor data are classified is greater than or equal to a threshold probability for abnormality. If the abnormality probability is greater than or equal to the threshold probability, abnormality identifier 716 can identify the sensor data set as abnormal.

In some embodiments, abnormality identifier 716 determines whether the sensor data set is normal or abnormal by identifying a maximum abnormality probability included in the set of abnormality probabilities. For example, if the abnormality probabilities generated by ML models 714 indicate the new set of sensor data are 10% for Mode A, 30% for Mode B, and 60% for Mode C, abnormality identifier 716 may identify 60% as the maximum abnormality probability. Abnormality identifier 716 can determine whether the maximum abnormality probability is greater than or equal to a threshold probability for abnormality and, if the abnormality probability is greater than or equal to the threshold probability, can identify the sensor data set as abnormal. Taking the maximum abnormality probability of a received set of abnormality probabilities can be a computationally simple process and can ensure that the sensor data set is treated cautiously to reduce a change of mislabeling the sensor data set as normal if the sensor data set is abnormal. In other words, taking the maximum abnormality probability may reduce the number of false negatives generated by sensor health system 700.

In some embodiments, abnormality identifier 716 determines whether the sensor data set is normal or abnormal by identifying a minimum abnormality probability included in the set of abnormality probabilities. For example, if the abnormality probabilities generated by ML models 714 indicate the new set of sensor data are 10% for Mode A, 30% for Mode B, and 60% for Mode C, abnormality identifier 716 may identify 10% as the minimum abnormality probability. Abnormality identifier 716 can determine whether the minimum abnormality probability is greater than or equal to a threshold probability for abnormality and, if the abnormality probability is greater than or equal to the threshold probability, can identify the sensor data set as abnormal. Taking the minimum abnormality probability of a received set of abnormality probabilities can be a computationally simple process and can ensure that the sensor data set is treated cautiously to reduce a change of mislabeling the sensor data set as abnormal if the sensor data set is normal for a particular mode or distribution. In other words, taking the minimum abnormality probability may reduce the number of false positives generated by sensor health system 700.

In some embodiments, abnormality identifier 716 labels the set of sensor data with an indication of whether the data set is normal or abnormal with respect to one or more of the distributions generated during the training phase. In some embodiments, abnormality identifier 716 determines a label for the sensor data set based on a model. In this case, abnormality identifier 716 can provide each abnormality probability of the received set of abnormality probabilities to the model to determine whether to classify the sensor data set as normal or abnormal. The model used by abnormality identifier 716 may include a supervised learning algorithm such as, for example, a logistic regression model, a support vector machine (SVM) model, decision trees, etc. Specifically, the model used by abnormality identifier 716 can determine a final probability based on each abnormality probability and can compare the final probability to the threshold probability.

The model utilized by abnormality identifier 716 can be trained to learn which features are particularly important for arriving at a correct label of normal or abnormal for a sensor data set. In some embodiments, the model accounts for differences in how the output probabilities of different models of ML models 714 are calibrated. In some embodiments, the model accounts for additional information such as machine specification values (e.g., gear ratio, line frequency, etc.) to better classify sensor data sets into particular modes and apply the corresponding distribution when determining whether the sensor data sets are normal or abnormal.

In some embodiments, abnormality identifier 716 includes business logic and/or auditing capabilities for further analyzing sensor data sets. In effect, abnormality identifier 716 may include any appropriate functionality for labeling sensor data sets as normal or abnormal. Based on a received set of abnormality probabilities, abnormality identifier 716 can label an associated sensor data set as normal or abnormal. If abnormality identifier 716 labels the sensor data set as normal, the sensor data set can be provided to a report generator 718 as described in greater detail below. However, if abnormality identifier 716 labels the sensor data set as abnormal, abnormality identifier 716 can provide the abnormal sensor data set to an analyst device 722.

Analyst device 722 can be any device associated with an analyst that can allow the analyst to view a sensor data set and provide feedback about the sensor data set. As such, analyst device 722 may include one or more personal computing devices associated with the analyst. Analyst device 722 may include any wearable or non-wearable device. Wearable devices can refer to any type of device that an individual wears including, but not limited to, a watch (e.g., a smart watch), glasses (e.g., smart glasses), bracelet (e.g., a smart bracelet), etc. Analyst device 722 may also include any type of mobile device including, but not limited to, a phone (e.g., smart phone), a tablet, a personal digital assistant, etc. In some embodiments, analyst device 722 includes other computing devices such as a desktop computer, a laptop computer, etc. Analyst device 722 can be configured to display a graphical user interface including sensor data sets to the analyst and receive user input to the graphical user interface. In some embodiments, analyst device 722 includes a touchscreen. Analyst device 722 may be communicable with the data set abnormality controller 700 via a network, for example a Wi-Fi network, a Bluetooth network, a cellular network, etc.

Via analyst device 722, the analyst can provide analyst feedback. Specifically, the analyst may indicate whether a sensor data set classified as abnormal by abnormality identifier 716 is actually abnormal in the opinion of the analyst. If the analyst indicates the sensor data set is normal, the sensor data set can be provided to report generator 718 such that report generator 718 can generate a “normal” report. However, if the analyst indicates the sensor data set is correctly classified as abnormal by abnormality identifier 716, various corrective actions may be taken to address the abnormality. In some embodiments, one corrective action is to provide the abnormal data set to report generator 718 to generate a report detailing the abnormality. In some embodiments, corrective actions such as maintenance, replacement, and/or other repairs of building equipment 720 may be initiated. For example, a specific building device of building equipment 720 may be scheduled to be replaced based on the analyst indicating an abnormality exists. Corrective actions may be initiated by the analyst via analyst device 722, automatically by abnormality identifier 716 and/or another component of data set abnormality controller 700, and/or by any other entity authorized to initiate corrective actions. In some embodiments, abnormality identifier 716 initiates a corrective action upon identifying the sensor data set as abnormal. In some embodiments, however, abnormality identifier 716 may be restricted in what corrective actions can be taken prior to confirming abnormality with the analyst. In this case, providing the sensor data set to the analyst may be considered a corrective action. Other corrective actions the abnormality identifier 716 may initiate may include providing the sensor data set to report generator 718 to generate an initial abnormal report for the vibration data set, alerting a user of user device 724 that abnormality may be present, stopping one or more artificial intelligence models or machine learning models that consume the sensor data, disabling building equipment 720 or operating other building equipment to work around a fault in building equipment 720, causing the sensor data to be discarded or withheld from one or more systems or processes that consume the sensor data, preventing the sensor data from being used to operate building equipment 720 or train a model used to operate the building equipment 720, withholding the sensor data from one or more user interfaces used to monitor operation of building equipment 720, or any combination thereof. Abnormality identifier 716 may be restricted, for example, from initiating a corrective action to replace building equipment before confirming abnormality with the analyst.

In some embodiments, abnormality identifier 716 provides abnormal data sets to multiple analyst devices 722. In this case, multiple analysts can review the abnormal data sets and provide feedback. Providing abnormal data sets to multiple analysts can reduce a chance that sensor data sets are mislabeled by analysts. For example, one analyst may accidentally misinterpret an abnormal data set provided by abnormality identifier 716 as normal, thereby missing an equipment fault. However, if the abnormal data set is provided to multiple analysts, the other analysts may detect the equipment fault in the abnormal data set. In some embodiments, if multiple analysts provide feedback on a supposedly abnormal data set, a predetermined percentage of analysts (e.g., 10% of analysts, 30% of analysts, 60% of analysts, etc.) may be required to indicate the supposedly abnormal data is truly abnormal for a corrective action to be initiated. In some embodiments, only one analyst (or another predetermined number of analysts) is required to indicate abnormality in a data set for a corrective action to be initiated.

Labeled sensor data sets can be provided to report generator 718. Based on a sensor data set, report generator 718 can automatically generate a report that can be provided to a user (e.g., a customer) of user device 724. In some embodiments, user device 724 is similar to and/or the same as analyst device 722. As such, user device 724 may be or include, for example, wearable devices, desktop computers, mobile devices, etc.

If a received sensor data set is labeled as normal, report generator 718 may generate a normal report indicating that building equipment is operating normally. If a received sensor data is labeled as abnormal (e.g., as indicated by an analyst), report generator 718 may generate an abnormal report detailing the abnormality. Abnormal reports may include various information that may be helpful to the user. For example, the abnormal report may include what building device of building equipment 720 is experiencing a fault, possible corrective actions that can be taken to address the fault, etc. In effect, the abnormal report can include any information that can help the user make an informed decision on how to proceed with regards to the fault.

### Flow Diagrams

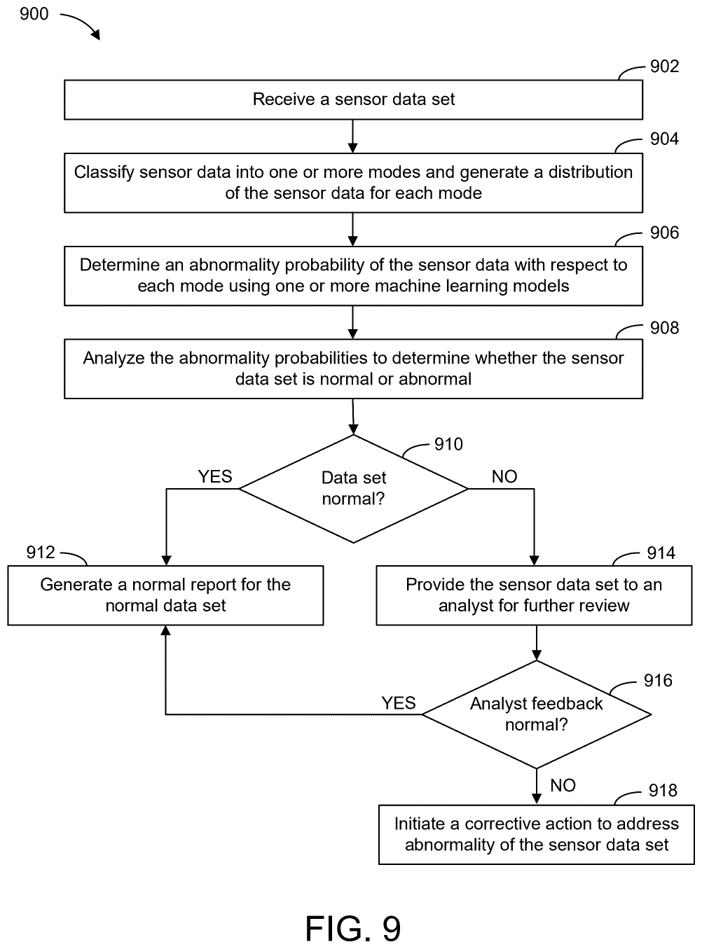

Referring now to FIG. 9, a flow diagram of a process 900 for detecting anomalies in a sensor data set and initiating corrective action is shown, according to some embodiments. Process 900 can outline how data sensor health system 700 can operate to analyze a sensor data set to determine if the sensor data set is normal or abnormal. As such, some and/or all steps of process 900 may be performed by sensor health system 700 and/or components thereof, as described with reference to FIGS. 7-8.

Process 900 is shown to include receiving a sensor data set (step 902). In some embodiments, step 902 is performed by sensor data collector 710 and can include any of the actions performed by sensor data collector 710, as described with reference to FIGS. 7-8. The sensor data set can include raw sensor measurements obtained from building equipment 720. The sensor data set can include timeseries data collected from one or more devices of building equipment 720. Each sample of the sensor data may include a data value (e.g., a measured value, a calculated value, etc.) and a timestamp indicating a time at which the sample was collected or generated. The sensor data set can include measurements of various states or conditions of building equipment 720 or affected by operation of building equipment 720 (e.g., temperature, pressure, flow rate, electric current, voltage, lighting, etc.). In some embodiments, the sensor data set includes metadata or other attributes indicating an operating mode of building equipment 720 at one or more times when the sensor data set was collected or generated.

Process 900 is shown to include classifying the sensor data into one or more modes and generating a distribution of the sensor data for each mode (step 904). In some embodiments, step 904 is performed by data set preparation module 712 and can include any of the actions performed by data set preparation module 712, as described with reference to FIGS. 7-8. Classifying the sensor data into modes can include identifying an operating mode of building equipment 720 for each sample of the sensor data (e.g., based on metadata embedded in the sensor data and/or other information available to sensor health system 700) and classifying each sample of the sensor data into a mode corresponding to the operating mode of building equipment 720 at the time that sample of the sensor data was collected. Different samples of the sensor data can be classified into different modes. For example, a first portion of the sensor data collected from a chiller temperature sensor during startup of the chiller may be classified into a first mode, whereas a second portion of the sensor data collected from the same chiller temperature sensor when the chiller was operating at steady state (e.g., after startup) may be classified into a second mode. An example of the modes into which a set of sensor data can be classified in step 904 is shown in FIG. 8 and described above.

Generating a distribution of the sensor data for each mode in step 904 may include generating a probability distribution (e.g., a probability density) of the sensor data values for the corresponding mode. For example, step 904 may include generating a probability distribution for a given mode of the sensor data by counting the number of data samples of the sensor data that are classified into the given mode and fall within various ranges of measured values. The percentage or proportion of the sensor data samples that fall within each range indicates the density of that range in the set of sensor data for the corresponding mode. Step 904 may include generating a distribution for each mode into which the sensor data are classified using the subset of the sensor data classified into that mode. For building equipment 720 which have multiple operating modes, this may result in a multi-modal distribution (i.e., a distribution that contains multiple different mode-specific distributions). Each mode-specific distribution of the multi-modal distribution may correspond to a particular operating mode of building equipment 720 and represents the distribution of the sensor data values for that operating mode. In some embodiments, step 904 includes generating a probability density function (PDF) for each mode of the sensor data. An example of the distributions and PDFs which can be generated in step 904 is shown in FIG. 8 and described above.

Process 900 is shown to include determining an abnormality probability of the sensor data with respect to each mode using one or more machine learning models (step 906). In some embodiments, step 906 is performed by ML models 714 and can include any of the actions performed by ML models 714, as described with reference to FIGS. 7-8. Alternatively, step 906 can be performed using any other type of model (e.g., non-machine learning models) and are not limited to using ML models 714. In some embodiments, ML models 714 include a mode-specific ML model for each of the modes into which the sensor data are classified in step 904 (and possibly additional modes). Each of the mode-specific ML models can be trained using sensor data collected during a training phase of sensor health system 700 (i.e., training data) and classified into the corresponding mode. For example, if the training data are classified into three modes (e.g., Mode A, Mode B, and Mode C, as shown in FIG. 8), three mode-specific ML models can be generated for use in step 904. Each of the mode-specific ML models can receive, as an input, a subset of the sensor data classified into the corresponding mode and/or the distribution of the sensor data generated for the corresponding mode in step 904 and may output an indication of whether the subset of the sensor data is normal or abnormal with respect to the corresponding mode. In other embodiments, ML models 714 include a single ML model which is trained using training data corresponding to multiple different modes. Such a ML model may be capable of classifying the sensor data received in step 902 as normal or abnormal with respect to each of the multiple different modes.

In some embodiments, step 906 includes processing each sample of the sensor data received in step 902 individually to determine whether that sample of sensor data is normal or abnormal with respect to each of the modes. In other embodiments, step 906 may include processing multiple samples of the sensor data received in step 902 concurrently by determining whether a given distribution of the new sensor data is similar or dissimilar to the distributions generated during the training phase. For example, step 906 may include comparing each of the mode-specific distributions generated in step 904 against a corresponding stored distribution for that mode (i.e., a distribution generated based on the training data) to determine whether the mode-specific distributions generated in step 904 are normal or abnormal with respect to the stored distributions for the corresponding modes.

In some embodiments, step 906 includes predicting a value or distribution of sensor data that is normal (e.g., normal for a given mode) based on the distributions generated for each mode in step 904. For example, the current mode of building equipment 720 can be provided as an input to step 906 and used to predict a normal value or distribution of the sensor data for that mode. The predicted values or distributions generated in step 906 can then be compared against the actual values or distributions of the sensor data received in step 902 to determine whether the sensor data are normal or abnormal. For example, if the actual value of a sample of the sensor data received in step 902 differs from the predicted value of the sensor data generated in step 906 by more than a threshold, step 906 may determine that the actual sample of sensor data is abnormal. Similarly, if the actual distribution of the sensor data generated in step 904 differs from the predicted distribution of the sensor data generated in step 906 by more than a threshold, step 906 may determine that the actual distribution of sensor data is abnormal. In some embodiments, step 906 includes assigning an abnormality probability to each sample or distribution of the sensor data based on the difference between the predicted value of the sensor data sample/distribution and the actual value of the sensor data sample/distribution, where larger differences correspond to larger abnormality probabilities.

In some embodiments, step 906 includes generating a set of abnormality probabilities that includes a probability that each sample of the sensor data received in step 902 or each distribution generated in step 904 is abnormal with respect to a given mode or distribution. For example, if the training data used to train ML models 714 are classified into three modes (e.g., Mode A, Mode B, and Mode C), step 906 can include determining a first abnormality probability for each sample or distribution of the sensor data with respect to Mode A, a second abnormality probability for each sample or distribution of the sensor data with respect to Mode B, and a third abnormality probability for each sample or distribution of the sensor data with respect to Mode C. In some embodiments, step 906 is more limited and only generates abnormality probabilities for the particular modes into which the sensor data received in step 902 are classified. For example, if a first half of the sensor data are classified into Mode A and a second half of the sensor data are classified into Mode B in step 904, step 906 may include determining an abnormality probability of the first half of the sensor data with respect to Mode A (but not with respect to Modes B or C) and determining an abnormality probability of the second half of the sensor data with respect to Mode B (but not with respect to Modes A or C). In this way, the set of abnormality probabilities generated in step 906 may be specific to the particular modes into which the sensor data are classified in step 904.

Process 900 is shown to include analyzing the abnormality probabilities to determine whether the sensor data set is normal or abnormal (step 908). In some embodiments, step 908 is performed by abnormality identifier 716 and can include any of the actions performed by abnormality identifier 716, as described with reference to FIGS. 7-8. Step 908 may include various operations to analyze the abnormality probabilities. For example, step 908 may include determining a maximum abnormality probability or minimum abnormality probability of all the abnormality probabilities generated in step 906 for a given sample or distribution of the sensor data received in step 902. In this case, if the maximum or minimum abnormality probability is greater than or equal to a threshold probability, the sensor data set may be considered abnormal. As another example, step 908 may include passing the abnormality probabilities through an additional model trained to determine whether a sensor data set is normal or abnormal based on a set of abnormality probabilities.

In some embodiments, step 908 includes using the mode into which each sample or distribution of the sensor data is classified in step 904 to determine whether the sensor data set is normal or abnormal. For example, step 908 may include discarding any abnormality probabilities that are not associated with the particular mode into which a given sample or distribution of the sensor data is classified. The remaining set of abnormality probabilities may include only the probabilities that a given sample or distribution of the sensor data is abnormal with respect to the mode into which the sample or distribution of the sensor data is classified in step 904. In this way, each sample or distribution of the sensor data may be determined as normal or abnormal with respect to the particular operating mode of building equipment 720 when the sensor data was collected. Accordingly, step 908 may include determining that the sensor data are normal if the sensor data have a sufficiently low abnormality probability (e.g., below a threshold) with respect to the mode into which the sensor data are classified in step 904, regardless of whether the sensor data are abnormal with respect to other modes.

Process 900 is shown to include determining whether the sensor data set is normal (step 910). Step 910 can be performed based on the analysis performed in step 908. If the sensor data set is normal (step 910, “YES”), process 900 can proceed to step 912. If the sensor data set is abnormal (step 910, “NO”), process 900 can proceed to step 914. In some embodiments, step 910 is performed by abnormality identifier 716 and can include any of the actions performed by abnormality identifier 716, as described with reference to FIGS. 7-8.

Process 900 is shown to include generating a normal report for the normal data set (step 912). If step 912 is performed, the sensor data set received in step 902 may be normal. As such, a normal data set can be generated and provided to a user (e.g., a customer) indicating that building equipment is operating as expected and that no faults are detected. In some embodiments, if the user indicates they do not wish to receive reports if no issues are present, step 912 may or may not be included in process 900. In some embodiments, step 912 is performed by report generator 718.

Process 900 is shown to include providing the sensor data set to an analyst for further review (step 914). If step 914 is performed, the analyst can be relied upon to provide further feedback regarding whether the sensor data set is actually abnormal. Step 914 may include providing the sensor data set to an analyst device. In some embodiments, information regarding why the sensor data set was labeled as abnormal in step 908 is provided to the analyst. For example, the analyst may be provided sections of the sensor data that were identified as potentially abnormal. In some embodiments, step 914 is performed by abnormality identifier 716 and can include any of the actions performed by abnormality identifier 716, as described with reference to FIGS. 7-8.

Process 900 is shown to include determining whether feedback from the analyst indicates the sensor data set is normal (step 916). If the analyst indicates the sensor data set is normal, process 900 can proceed to step 912. If the analyst indicates the sensor data set is abnormal, process 900 can proceed to step 918. In some embodiments, step 916 is performed by abnormality identifier 716 and can include any of the actions performed by abnormality identifier 716, as described with reference to FIGS. 7-8.

Process 900 is shown to include initiating a corrective action to address abnormality of the sensor data set (step 918). Responsive to the analyst indicating the data set is abnormal, the corrective action can be initiated. The corrective action may include various actions such as, for example, generating a report indicating the abnormality, scheduling maintenance, repair, or replacement of building equipment to be performed, disabling a building device with a fault, obtaining further feedback from analysts, etc. In some embodiments, step 916 is performed by sensor health system 700 and can include any of the actions performed by sensor health system 700, as described with reference to FIGS. 7-8.

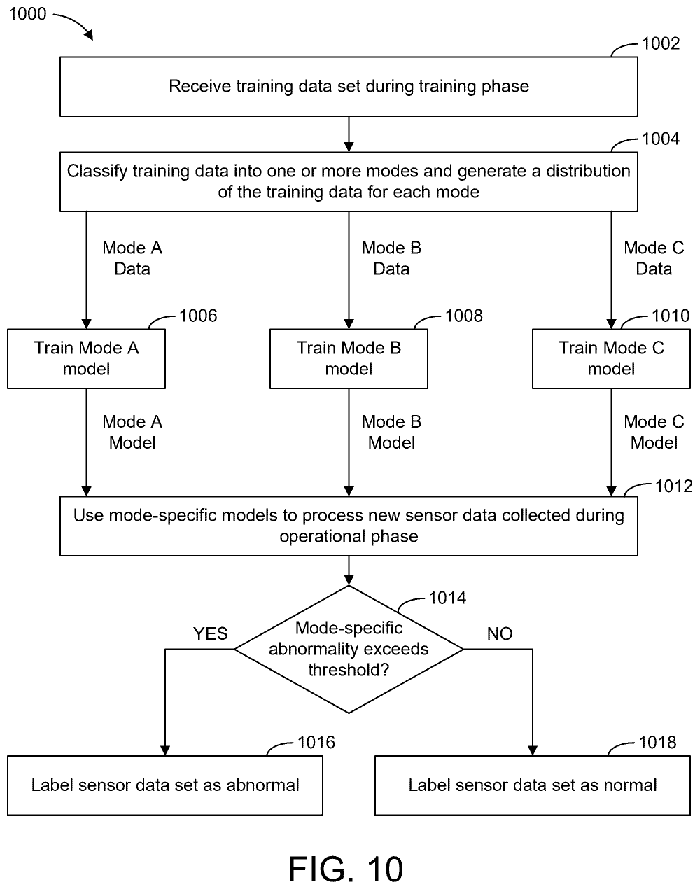

Referring now to FIG. 10, a flow diagram of a process 1000 for training and using mode-specific models to label sensor data as normal or abnormal is shown, according to an exemplary embodiment. Process 1000 can be performed by one or more components of sensor health system 700 as described with reference to FIGS. 7-8. Process 1000 can be performed to generate the machine learning models used in step 906 of process 900 (e.g., ML models 914) for embodiments in which a separate ML model is generated for each mode of the sensor data. The mode-specific models generated by process 1000 can then be used to determine whether new sensor data obtained during an operational phase of sensor health system 700 is normal or abnormal with respect to each mode.

Process 1000 is shown to include receiving a training data set during a training phase of sensor health system 700 (step 1002). In some embodiments, step 1002 is performed by sensor data collector 710 and can include any of the actions performed by sensor data collector 710, as described with reference to FIGS. 7-8. Step 1002 may be similar to step 902 of process 900 with the exception that the data received in step 1002 is collected during a training phase of sensor health system 700. The training data received in step 1002 can include raw sensor measurements from sensors or other types of timeseries data obtained from building equipment 720. Each sample of the training data may include a data value (e.g., a measured value, a calculated value, etc.) and a timestamp indicating a time at which the sample was collected or generated. The training data set can include measurements of various states or conditions of building equipment 720 or affected by operation of building equipment 720 (e.g., temperature, pressure, flow rate, electric current, voltage, lighting, etc.). In some embodiments, the training data set includes metadata or other attributes indicating an operating mode of building equipment 720 at one or more times when the training data set was collected or generated.

Process 1000 is shown to include classifying the training data into one or more modes and generating a distribution of the training data for each mode (step 1004). In some embodiments, step 904 is performed by data set preparation module 712 and can include any of the actions performed by data set preparation module 712, as described with reference to FIGS. 7-8. Step 1004 may be similar to step 904 of process 900 with the exception that the data used in step 1004 is training data collected during a training phase of sensor health system 700. For example, step 1004 may include identifying an operating mode of building equipment 720 for each sample of the training data (e.g., based on metadata embedded in the training data and/or other information available to sensor health system 700) and classifying each sample of the training data into a mode corresponding to the operating mode of building equipment 720 at the time that sample of the training data was collected or generated. Different samples of the training data can be classified into different modes. For example, a first portion of the training data collected from a chiller temperature sensor during startup of the chiller may be classified into a first mode, whereas a second portion of the training data collected from the same chiller temperature sensor when the chiller was operating at steady state (e.g., after startup) may be classified into a second mode. An example of the modes into which a set of training data can be classified in step 1004 is shown in FIG. 8 and described above.

Generating a distribution of the training data for each mode in step 1004 may include generating a probability distribution (e.g., a probability density) of the training data values for the corresponding mode. For example, step 1004 may include generating a probability distribution for a given mode of the training data by counting the number of data samples of the training data that are classified into the given mode and fall within various ranges of measured or calculated values. The percentage or proportion of the training data samples that fall within each range indicates the density of that range in the set of training data for the corresponding mode. Step 1004 may include generating a distribution for each mode into which the training data are classified using the subset of the training data classified into that mode. For building equipment 720 which have multiple operating modes, this may result in a multi-modal distribution (i.e., a distribution that contains multiple different mode-specific distributions). Each mode-specific distribution of the multi-modal distribution may correspond to a particular operating mode of building equipment 720 and represents the distribution of the training data values for that operating mode. In some embodiments, step 1004 includes generating a probability density function (PDF) for each mode of the training data. An example of the distributions and PDFs which can be generated in step 1004 is shown in FIG. 8 and described above.

Process 1000 is shown to include training multiple mode-specific models including a Mode A model (step 1006), a Mode B model (step 1008), and a Mode C model (step 1010). Although three mode-specific models are shown in FIG. 10 as an example, it should be understood that the number of mode-specific models trained in process 1000 can include any number of models depending on the number of operating modes of building equipment 720. For bi-modal building equipment, the number of models trained in process 1000 may include two models (i.e., one model for each of the two operating modes), whereas three or more models may be trained for building equipment 720 with three or more operating modes (i.e., one model for each of the three or more operating modes). Each model may be trained using a subset of the training data set corresponding to the model-specific mode. For example, a first subset of the training data set classified into Mode A in step 1004 can be used to train the Mode A model in step 1006, a second subset of the training data set classified into Mode B in step 1004 can be used to train the Mode B model in step 1008, and a third subset of the training data set classified into Mode C in step 1004 can be used to train the Mode C model in step 1010. In some embodiments, each model trained in steps 1006-1010 can be configured to predict values or distributions of sensor data that are normal for the corresponding mode.

Process 1000 is shown to include using the mode-specific models to process new sensor data collected during an operational phase of sensor health system 700 (step 1012). In some embodiments, step 1012 is performed by ML models 714 and can include any of the actions performed by ML models 714, as described with reference to FIGS. 7-8. The operational phase may include a time period occurring after the training phase or may overlap at least partially with the training phase in some embodiments (e.g., including a terminal portion of the training phase and/or a time period after the training phase). Each of the mode-specific models trained in process 1000 can be configured to receive new samples of sensor data collected during the operational phase of sensor health system 700 and determine whether the new sensor data are normal or abnormal with respect to the particular mode corresponding to the model. For example, the Mode A model trained in step 1006 can be used to determine whether the new sensor data are normal or abnormal with respect to Mode A, the Mode B model trained in step 1008 can be used to determine whether the new sensor data are normal or abnormal with respect to Mode B, and the Mode C model trained in step 1010 can be used to determine whether the new sensor data are normal or abnormal with respect to Mode C.

In some embodiments, step 1012 includes classifying various subsets of the new sensor data into one or more modes and providing the classified subsets of the sensor data as inputs to the mode-specific models based on the particular modes into which the subsets of the sensor data are classified. For example, a first subset of the sensor data classified into Mode A can be provided as input to the Mode A model, a second subset of the sensor data classified into Mode B can be provided as input to the Mode B model, and a third subset of the sensor data classified into Mode C can be provided as input to the Mode C model in step 1012. Alternatively, each subset of the sensor data or all of the sensor data can be provided as inputs to each of the mode-specific models to determine whether the sensor data are normal or abnormal with respect to each of the multiple modes. The classification performed in step 1012 may be the same as or similar to the classification performed in step 1004, with the exception that the classification is applied to the new sensor data obtained in step 1012 instead of the training data received in step 1002. In some embodiments, the classification is performed using a neural network, machine learning model, or other type of classification model.

In some embodiments, step 1012 includes using each mode-specific model to process the subset of sensor data classified into the mode corresponding to that model to determine whether the sensor data are normal or abnormal with respect to that mode. The mode-specific models may output an indication of whether the sensor data are normal or abnormal with respect to the corresponding mode. The indication may include an abnormality probability (e.g., 30% likelihood of being abnormal, 10% likelihood of being abnormal, etc.) or a binary indication of abnormality (e.g., normal or abnormal) in various embodiments. Each of the abnormality probabilities or other indications may be specific to a given subset of the sensor data with respect to a particular mode. In various embodiments, step 1012 may include processing each sample of the sensor data individually to determine whether each sample of the sensor data is abnormal with respect to a particular mode, or processing multiple samples of the sensor data as a group (i.e., a distribution of the sensor data) to determine whether the distribution of sensor data is abnormal with respect to a particular mode.

Process 1000 is shown to include determining whether a mode-specific abnormality exceeds a threshold (step 1014). In some embodiments, step 1014 is performed by abnormality identifier 716 and can include any of the actions performed by abnormality identifier 716, as described with reference to FIGS. 7-8. Step 1014 may include comparing each of the abnormality probabilities generated in step 1012 against a corresponding threshold to determine whether each sample or distribution of the sensor data is normal or abnormal. In some embodiments, step 1014 includes determining a maximum abnormality probability or minimum abnormality probability of all the abnormality probabilities generated in step 1012 for a given sample or distribution of the sensor data received in step 1012. In this case, if the maximum or minimum abnormality probability is greater than or equal to a threshold probability, the sensor data may be considered abnormal. As another example, step 1014 may include passing the abnormality probabilities through an additional model trained to determine whether a sensor data set is normal or abnormal based on a set of abnormality probabilities.

If the mode-specific abnormality probability for a sample or distribution of the sensor data exceeds the threshold (step 1014, “YES”), process 1000 can proceed to step 1016. In step 1016, the sample or distribution of the sensor data is labeled as abnormal with respect to the particular mode for which the mode-specific abnormality probability exceeds the threshold in step 1014. Step 1016 can be repeated for each sample or distribution of the sensor data and/or for each of the mode-specific models that determined the sensor data is abnormal. In some embodiments, step 1016 includes applying multiple abnormal labels to a given sample or subset of the sensor data. Each label may indicate that the sensor data abnormal with respect to a particular mode. For example, consider a scenario in which a given sample or distribution of the sensor data is determined to be normal with respect to Mode A, but abnormal with respect to Mode B and Mode C in steps 1012-1014. In this scenario, step 1016 may include a first abnormal label to the sensor data indicating the sensor data is abnormal with respect to Mode B and a second abnormal label to the sensor data indicating the sensor data is abnormal with respect to Mode C. In some embodiments, a single abnormal label is applied to the sensor data indicating each of the multiple modes with respect to which the sensor data is considered abnormal (e.g., abnormal for Modes B and C).

In some embodiments, labeling the sensor data as abnormal in step 1016 causes the sensor data to be flagged for review by a human analyst as described with reference to process 900. In some embodiments, labeling the sensor data as abnormal in step 1016 causes the sensor data to be discarded or withheld from one or more downstream systems or processes that consume the sensor data. For example, any sensor data labeled as abnormal in step 1016 may be withheld from a controller that uses the sensor data (e.g., as feedback) to operate building equipment 720 or other equipment in the BMS. As another example, any sensor data labeled as abnormal in step 1016 may be withheld from a downstream application that consumes the sensor data as part of a model predictive control process, a model predictive maintenance process, or other process. In some embodiments, any sensor data labeled as abnormal in step 1016 may be withheld from a system that uses the sensor data to train one or more models used to operate building equipment 720 or other equipment in the BMS. In some embodiments, labeling the sensor data as abnormal in step 1016 may cause one or more artificial intelligence models or machine learning models that consume the sensor data to stop their operation.

Conversely, if the mode-specific abnormality probability for a sample or distribution of the sensor data does not exceed the threshold (step 1014, “NO”), process 1000 can proceed to step 1018. In step 1018, the sample or distribution of the sensor data is labeled as normal with respect to the particular mode for which the mode-specific abnormality probability does not exceed the threshold in step 1014. Step 1018 can be repeated for each sample or distribution of the sensor data and/or for each of the mode-specific models that determined the sensor data is normal. In some embodiments, step 1016 includes applying multiple normal labels to a given sample or subset of the sensor data. Each label may indicate that the sensor data normal with respect to a particular mode. For example, consider a scenario in which a given sample or distribution of the sensor data is determined to be normal with respect to Mode A and Mode B, but abnormal with respect to Mode C in steps 1012-1014. In this scenario, step 1018 may include a first normal label to the sensor data indicating the sensor data is abnormal with respect to Mode A and a second normal label to the sensor data indicating the sensor data is normal with respect to Mode B. In some embodiments, a single normal label is applied to the sensor data indicating each of the multiple modes with respect to which the sensor data is considered normal (e.g., abnormal for Modes A and B).

In some embodiments, labeling the sensor data as normal in step 1018 causes the sensor data to be excluded from review by a human analyst as described with reference to process 900. In some embodiments, labeling the sensor data as normal in step 1018 causes the sensor data to be provided to one or more downstream systems or processes that consume the sensor data. For example, any sensor data labeled as normal in step 1018 may be provided to a controller that uses the sensor data (e.g., as feedback) to operate building equipment 720 or other equipment in the BMS. As another example, any sensor data labeled as normal in step 1018 may be provided to a downstream application that consumes the sensor data as part of a model predictive control process, a model predictive maintenance process, or other process. In some embodiments, any sensor data labeled as normal in step 1018 may be provided to a system that uses the sensor data to train one or more models used to operate building equipment 720 or other equipment in the BMS.

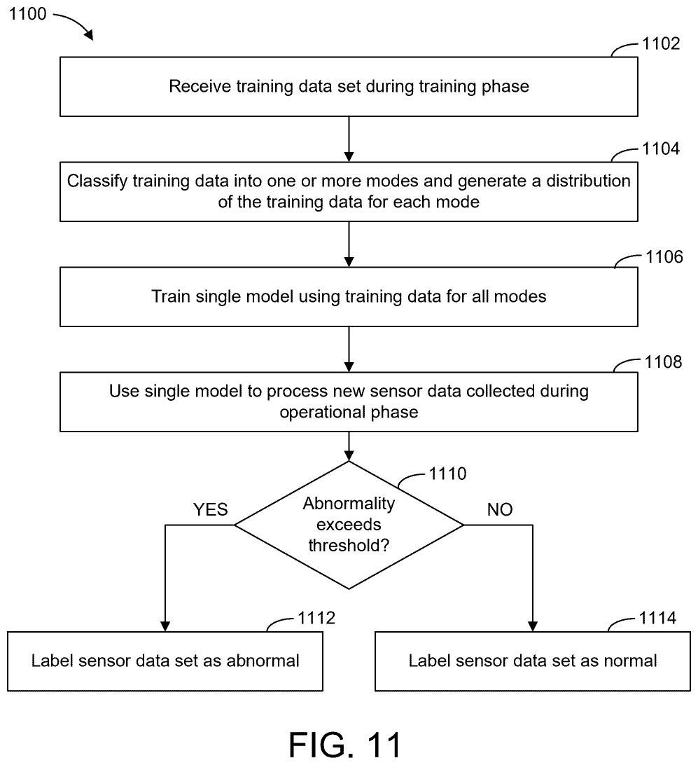

Referring now to FIG. 11, is a flow diagram of a process 1100 for training and using a single model to label sensor data as normal or abnormal is shown, according to an exemplary embodiment. Process 1100 can be performed by one or more components of sensor health system 700 as described with reference to FIGS. 7-8. Process 1100 can be performed to generate a machine learning model used in step 906 of process 900 (e.g., ML models 914) for embodiments in which a single ML model is generated for processing all modes of the sensor data. The modes generated by process 1100 can then be used to determine whether new sensor data obtained during an operational phase of sensor health system 700 is normal or abnormal with respect to each mode.

Process 1100 is shown to include many of the same steps as process 1000. For example, process 1100 is shown to include receiving a training data set during a training phase of sensor health system 700 (step 1102) and classifying the training data into one or more modes and generating a distribution of the training data for each mode (step 1104). These steps may be the same as or similar to step 1002 and step 1004 of process 1000, as described with reference to FIG. 10.

Process 1000 is shown to include training a single model using the training data for all modes (step 1106). Step 1106 may be the same as or similar to steps 1006-1010 of process 1000, with the exception that a single model is trained for all modes in step 1106 rather than training multiple mode-specific models for each mode individually in steps 1006-1010. Step 1106 can include providing each subset of the training data received in step 1102 and the corresponding mode classifications and/or distributions generated in step 1104 as inputs to the model training process and using such inputs to train the model. Step 1106 can include training the model to learn the values and/or distributions of the training data that are normal or abnormal for each mode into which the training data are classified. In some embodiments, the model trained in step 1106 can be configured to predict values or distributions of sensor data that are normal for each of the modes.

Process 1100 is shown to include using the single model to process new sensor data collected during an operational phase of sensor health system 700 (step 1108). In some embodiments, step 1108 is performed by ML models 714 and can include any of the actions performed by ML models 714, as described with reference to FIGS. 7-8. Step 1108 may be the same as or similar to step 1012 of process 1000, with the exception that the single model trained in step 1106 is used to process the sensor data for all modes rather than using multiple mode-specific models to process the sensor data in step 1012. In some embodiments, step 1108 includes classifying various subsets of the new sensor data into one or more modes and providing the classified subsets of the sensor data as inputs to the single model trained in step 1106. The model can be used to determine whether each subset of the sensor data is normal or abnormal with respect to the particular mode into which the subset of the sensor data is classified. The classification performed in step 1108 may be the same as or similar to the classification performed in step 1104, with the exception that the classification is applied to the new sensor data obtained in step 1108 instead of the training data received in step 1102. In some embodiments, the classification is performed using a neural network, machine learning model, or other type of classification model.

In some embodiments, step 1108 includes using the single model to process each subset of sensor data to determine whether the sensor data are normal or abnormal with respect to one or more of the modes. In various embodiments, step 1108 may include using the single model to determine whether each subset of the sensor data is normal or abnormal with respect to the particular mode into which the subset of sensor data are classified or with respect to all of the modes. The model may output an indication of whether the sensor data are normal or abnormal with respect to one or more of the modes. The indication may include an abnormality probability (e.g., 30% likelihood of being abnormal, 10% likelihood of being abnormal, etc.) or a binary indication of abnormality (e.g., normal or abnormal) in various embodiments. Each of the abnormality probabilities or other indications may be specific to a given subset of the sensor data with respect to a particular mode. In various embodiments, step 1108 may include processing each sample of the sensor data individually to determine whether each sample of the sensor data is abnormal with respect to a particular mode, or processing multiple samples of the sensor data as a group (i.e., a distribution of the sensor data) to determine whether the distribution of sensor data is abnormal with respect to a particular mode.

Process 1100 is shown to include determining whether an abnormality exceeds a threshold (step 1100). In some embodiments, step 1110 is performed by abnormality identifier 716 and can include any of the actions performed by abnormality identifier 716, as described with reference to FIGS. 7-8. Step 1110 may be the same as or similar to step 1014 of process 1000 as described with reference to FIG. 10, with the exception that the abnormality evaluated in step 1110 may be more general than the mode-specific abnormality probabilities evaluated in step 1014 of process 1000.

In some embodiments, the abnormality probability evaluated in step 1110 may be a minimum of the mode-specific abnormality probabilities generated in step 1108. Using the minimum mode-specific abnormality probability allows step 1110 to consider whether a given sample or distribution of the sensor data is normal or abnormal with respect to the most suitable (i.e., closest matching) mode of the sensor data. For example, consider a scenario in which a given sample or distribution of the sensor data has an abnormality probability of 10% with respect to Mode A, an abnormality probability of 80% with respect to Mode B, and an abnormality probability of 95% with respect to Mode C. Selecting the minimum abnormality probability (i.e., 10% in this scenario) allows step 1110 to consider whether the sample or distribution of sensor data is abnormal with respect to the broad range of operating modes of building equipment 720 considered as a whole.

In some embodiments, the abnormality probability evaluated in step 1110 is a mode-specific abnormality probability for a given mode of the sensor data. In this scenario, each mode-specific abnormality probability may be evaluated separately to determine whether the sample or distribution of the sensor data is normal or abnormal with respect to each of the modes. In this embodiment, step 1110 may be substantially the same as or similar to step 1114 of process 1000, as described with reference to FIG. 10.

If the abnormality probability for a sample or distribution of the sensor data exceeds the threshold (step 1110, “YES”), process 1100 can proceed to step 1112. In step 1112, the sample or distribution of the sensor data is labeled as abnormal. Depending on whether the decision in step 1110 is mode-specific, the label applied in step 1112 can be for a specific mode of the sensor data (e.g., abnormal with respect to Mode A) or for all modes considered as a group (e.g., abnormal for all modes). Step 1112 can be repeated for each sample or distribution of the sensor data and/or for each of the modes for which the sensor data is determined to be abnormal in step 1110. In some embodiments, step 1112 includes applying multiple abnormal labels to a given sample or subset of the sensor data. Each label may indicate that the sensor data abnormal with respect to a particular mode. For example, consider a scenario in which a given sample or distribution of the sensor data is determined to be normal with respect to Mode A, but abnormal with respect to Mode B and Mode C in steps 1108-1110. In this scenario, step 1112 may include a first abnormal label to the sensor data indicating the sensor data is abnormal with respect to Mode B and a second abnormal label to the sensor data indicating the sensor data is abnormal with respect to Mode C. In some embodiments, a single abnormal label is applied to the sensor data indicating each of the multiple modes with respect to which the sensor data is considered abnormal (e.g., abnormal for Modes B and C).

In some embodiments, labeling the sensor data as abnormal in step 1112 causes the sensor data to be flagged for review by a human analyst as described with reference to process 900. In some embodiments, labeling the sensor data as abnormal in step 1112 causes the sensor data to be discarded or withheld from one or more downstream systems or processes that consume the sensor data. For example, any sensor data labeled as abnormal in step 1112 may be withheld from a controller that uses the sensor data (e.g., as feedback) to operate building equipment 720 or other equipment in the BMS. As another example, any sensor data labeled as abnormal in step 1112 may be withheld from a downstream application that consumes the sensor data as part of a model predictive control process, a model predictive maintenance process, or other process. In some embodiments, any sensor data labeled as abnormal in step 1112 may be withheld from a system that uses the sensor data to train one or more models used to operate building equipment 720 or other equipment in the BMS.

Conversely, if the abnormality probability for a sample or distribution of the sensor data does not exceed the threshold (step 1110, “NO”), process 1110 can proceed to step 1114. Depending on whether the decision in step 1110 is mode-specific, the label applied in step 1114 can be for a specific mode of the sensor data (e.g., normal with respect to Mode A) or for the set of modes considered as a group (e.g., normal for one or more of the modes). Step 1114 can be repeated for each sample or distribution of the sensor data and/or for each of the modes for which the sensor data is normal. In some embodiments, step 1114 includes applying multiple normal labels to a given sample or subset of the sensor data. Each label may indicate that the sensor data normal with respect to a particular mode. For example, consider a scenario in which a given sample or distribution of the sensor data is determined to be normal with respect to Mode A and Mode B, but abnormal with respect to Mode C in steps 1108-1110. In this scenario, step 1114 may include a first normal label to the sensor data indicating the sensor data is abnormal with respect to Mode A and a second normal label to the sensor data indicating the sensor data is normal with respect to Mode B. In some embodiments, a single normal label is applied to the sensor data indicating each of the multiple modes with respect to which the sensor data is considered normal (e.g., abnormal for Modes A and B).

In some embodiments, labeling the sensor data as normal in step 1114 causes the sensor data to be excluded from review by a human analyst as described with reference to process 900. In some embodiments, labeling the sensor data as normal in step 1114 causes the sensor data to be provided to one or more downstream systems or processes that consume the sensor data. For example, any sensor data labeled as normal in step 1114 may be provided to a controller that uses the sensor data (e.g., as feedback) to operate building equipment 720 or other equipment in the BMS. As another example, any sensor data labeled as normal in step 1114 may be provided to a downstream application that consumes the sensor data as part of a model predictive control process, a model predictive maintenance process, or other process. In some embodiments, any sensor data labeled as normal in step 1114 may be provided to a system that uses the sensor data to train one or more models used to operate building equipment 720 or other equipment in the BMS.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A sensor health system for building equipment, the sensor health system comprising:
one or more processors; and
one or more non-transitory computer-readable media storing instructions that, when executed by the one or more processors, cause the one or more processors to perform operations comprising:
obtaining sensor data measuring a variable state or condition affected by operating the building equipment;
classifying the sensor data into a particular mode of a plurality of modes corresponding to a plurality of operating states of the building equipment;
generating a mode-specific distribution of the sensor data corresponding to the particular mode of the plurality of modes;
identifying the sensor data as abnormal by comparing the mode-specific distribution of the sensor data to an expected mode-specific distribution selected from a plurality of expected mode-specific distributions corresponding to the plurality of modes; and
initiating a corrective action in response to identifying the sensor data as abnormal.

2. The sensor health system of claim 1, the operations comprising
obtaining an expected multi-modal distribution comprising the plurality of expected mode-specific distributions;
identifying a corresponding mode for each of the plurality of expected mode-specific distributions in the expected multi-modal distribution; and
selecting the expected mode-specific distribution in response to determining that the expected mode-specific distribution corresponds to the particular mode into which the sensor data are classified.

3. The sensor health system of claim 1, the operations comprising generating an expected multi-modal distribution comprising the plurality of expected mode-specific distributions by:
classifying a set of training data into each of the plurality of modes;
generating, for each mode of the plurality of modes, an expected mode-specific distribution for the mode using a portion of the set of training data classified into the mode; and
generating the expected multi-modal distribution by incorporating each expected mode-specific distribution into the expected multi-modal distribution.

4. The sensor health system of claim 1, wherein identifying the sensor data as abnormal comprises:
using a machine learning model to determine an abnormality of the mode-specific distribution of the sensor data relative to the expected mode-specific distribution; and
identifying the sensor data as abnormal in response to the abnormality exceeding a threshold.

5. The sensor health system of claim 1, wherein:
classifying the sensor data comprises classifying a first portion of the sensor data into a first mode of the plurality of modes and classifying a second portion of the sensor data into a second mode of the plurality of modes;
generating the mode-specific distribution comprises generating a first mode-specific distribution of the sensor data using the first portion of the sensor data classified into the first mode and generating a second mode-specific distribution of the sensor data using the second portion of the sensor data classified into the second mode; and
identifying the sensor data as abnormal comprises comparing the first mode-specific distribution of the sensor data to a first expected mode-specific distribution corresponding to the first mode and comparing the second mode-specific distribution of the sensor data to a second expected mode-specific distribution corresponding to the second mode.

6. The sensor health system of claim 5, wherein identifying the sensor data as abnormal comprises:
using a first machine learning model to determine a first abnormality of the first mode-specific distribution of the sensor data relative to the first expected mode-specific distribution;
using a second machine learning model to determine a second abnormality of the second mode-specific distribution of the sensor data relative to the second expected mode-specific distribution; and
identifying the sensor data as abnormal in response to at least one of the first abnormality or the second abnormality exceeding a threshold.

7. The sensor health system of claim 5, wherein identifying the sensor data as abnormal comprises:
using a single machine learning model to determine both:
a first abnormality of the first mode-specific distribution of the sensor data relative to the first expected mode-specific distribution; and
a second abnormality of the second mode-specific distribution of the sensor data relative to the second expected mode-specific distribution; and
identifying the sensor data as abnormal in response to at least one of the first abnormality or the second abnormality exceeding a threshold.

8. The sensor health system of claim 1, wherein initiating the corrective action comprises at least one of:
transmitting the sensor data to an analyst and obtaining feedback from the analyst;
initiating maintenance, repair, or replacement of the building equipment or a sensor from which the sensor data are obtained;
stopping one or more artificial intelligence models or machine learning models that consume the sensor data; or
disabling the building equipment or operating other building equipment to work around a fault in the building equipment.

9. The sensor health system of claim 1, wherein initiating the corrective action comprises at least one of:
causing the sensor data to be discarded or withheld from one or more systems or processes that consume the sensor data;
preventing the sensor data from being used to operate the building equipment or train a model used to operate the building equipment; or
withholding the sensor data from one or more user interfaces used to monitor operation of the building equipment.

10. The sensor health system of claim 1, the operations comprising:
labeling the sensor data as abnormal in response to identifying the sensor data as abnormal; and
labeling the sensor data as normal in response to identifying the sensor data as normal.

11. A building management system comprising:
one or more processors; and
one or more non-transitory computer-readable media storing instructions that, when executed by the one or more processors, cause the one or more processors to perform operations comprising:
obtaining timeseries data relating to operation of building equipment;
classifying the timeseries data into a particular mode of a plurality of modes corresponding to a plurality of operating states of the building equipment;
generating a mode-specific distribution of the timeseries data corresponding to the particular mode of the plurality of modes;
identifying the timeseries data as abnormal by comparing the mode-specific distribution of the timeseries data to an expected mode-specific distribution selected from a plurality of expected mode-specific distributions corresponding to the plurality of modes; and
initiating a corrective action in response to identifying the timeseries data as abnormal.

12. The building management system of claim 11, the operations comprising generating an expected multi-modal distribution comprising the plurality of expected mode-specific distributions by:
classifying a set of training data into each of the plurality of modes;
generating, for each mode of the plurality of modes, an expected mode-specific distribution for the mode using a portion of the set of training data classified into the mode; and
generating the expected multi-modal distribution by incorporating each expected mode-specific distribution into the expected multi-modal distribution.

13. The building management system of claim 11, wherein:
classifying the timeseries data comprises classifying a first portion of the timeseries data into a first mode of the plurality of modes and classifying a second portion of the timeseries data into a second mode of the plurality of modes;
generating the mode-specific distribution comprises generating a first mode-specific distribution of the timeseries data using the first portion of the timeseries data classified into the first mode and generating a second mode-specific distribution of the timeseries data using the second portion of the timeseries data classified into the second mode; and
identifying the timeseries data as abnormal comprises comparing the first mode-specific distribution of the timeseries data to a first expected mode-specific distribution corresponding to the first mode and comparing the second mode-specific distribution of the timeseries data to a second expected mode-specific distribution corresponding to the second mode.

14. The building management system of claim 13, wherein identifying the timeseries data as abnormal comprises:
using a first machine learning model to determine a first abnormality of the first mode-specific distribution of the timeseries data relative to the first expected mode-specific distribution;
using a second machine learning model to determine a second abnormality of the second mode-specific distribution of the timeseries data relative to the second expected mode-specific distribution; and
identifying the sensor data as abnormal in response to at least one of the first abnormality or the second abnormality exceeding a threshold.

15. The building management system of claim 13, wherein identifying the timeseries data as abnormal comprises:
using a single machine learning model to determine both:
a first abnormality of the first mode-specific distribution of the timeseries data relative to the first expected mode-specific distribution; and
a second abnormality of the second mode-specific distribution of the timeseries data relative to the second expected mode-specific distribution; and
identifying the timeseries data as abnormal in response to at least one of the first abnormality or the second abnormality exceeding a threshold.

16. A method for initiating corrective actions for building equipment, the method comprising:
obtaining timeseries data relating to operation of the building equipment;
classifying the timeseries data into a particular mode of a plurality of modes corresponding to a plurality of operating states of the building equipment;
generating a mode-specific distribution of the timeseries data corresponding to the particular mode of the plurality of modes;
identifying the timeseries data as abnormal by comparing the mode-specific distribution of the timeseries data to an expected mode-specific distribution selected from a plurality of expected mode-specific distributions corresponding to the plurality of modes; and
initiating a corrective action in response to identifying the timeseries data as abnormal.

17. The method of claim 16, comprising generating an expected multi-modal distribution comprising the plurality of expected mode-specific distributions by:
classifying a set of training data into each of the plurality of modes;
generating, for each mode of the plurality of modes, an expected mode-specific distribution for the mode using a portion of the set of training data classified into the mode; and
generating the expected multi-modal distribution by incorporating each expected mode-specific distribution into the expected multi-modal distribution.

18. The method of claim 16, wherein:
classifying the timeseries data comprises classifying a first portion of the timeseries data into a first mode of the plurality of modes and classifying a second portion of the timeseries data into a second mode of the plurality of modes;
generating the mode-specific distribution comprises generating a first mode-specific distribution of the timeseries data using the first portion of the timeseries data classified into the first mode and generating a second mode-specific distribution of the timeseries data using the second portion of the timeseries data classified into the second mode; and
identifying the timeseries data as abnormal comprises comparing the first mode-specific distribution of the timeseries data to a first expected mode-specific distribution corresponding to the first mode and comparing the second mode-specific distribution of the timeseries data to a second expected mode-specific distribution corresponding to the second mode.

19. The method of claim 18, wherein identifying the timeseries data as abnormal comprises:
using one or more machine learning models to determine a first abnormality of the first mode-specific distribution of the timeseries data relative to the first expected mode-specific distribution;
using the one or more machine learning models to determine a second abnormality of the second mode-specific distribution of the timeseries data relative to the second expected mode-specific distribution; and
identifying the sensor data as abnormal in response to at least one of the first abnormality or the second abnormality exceeding a threshold.

20. The method of claim 16, wherein classifying the timeseries data into the particular mode comprises using at least one of a machine learning model or operating states of the building equipment to determine the particular mode based on data characterizing operation of the building equipment at a time when the timeseries data are generated or collected.
